(19) United States
(12) Patent Application Publication
(10) Pub. No.: US 2004/0014624 A1
(43) Pub. Date: Jan. 22, 2004

(54) Recylable cleaning compositions

(76) Inventors: Steven A. Bolkan, Hopewell, NJ (US); Mark Ventura, Freehold, NJ (US); Bruce Strasser, Lawrenceville, NJ (US); Stephen W. Barrow, Freehold, NJ (US); Michael Endres, Woodbridge, IL (US)

Correspondence Address: Stephen B Shear, Church & Dwight Company Inc, 469 North Harrison Street, Princeton, NJ, 08543, US

(21) Appl. No.: 10/296,777

(22) PCT Filed: Jun. 6, 2001
(86) PCT No.: PCT/US01/18546

(51) Int. Cl. C11D 17/00

(52) U.S. Cl. 510/296; 510/297; 510/421; 510/470; 510/490

(57) ABSTRACT

A recyclable cleaning composition comprising an alkaline solution of at least one surfactant is disclosed. The cleaning composition has improved surfactant recovery upon membrane filtration.

### RELATED APPLICATION DATA

This application claims priority under 35 U.S.C. §119 from provisional application serial No. 60/209,765, filed Jun. 6, 2000.

### FIELD OF THE INVENTION

The present invention relates to recyclable cleaning compositions. More particularly, the invention relates to cleaning compositions including an alkaline solution of at least one surfactant and having improved surfactant recovery upon membrane filtration of the solution.

### BACKGROUND OF THE INVENTION

An aqueous cleaning process for cleaning soiled hard surface articles, in its basic form includes a cleaning stage, a rinsing stage, and a drying stage. Hard surface articles cleaned by such a process include metal, glass, plastic and ceramic articles. Soils typically present on hard surface articles include contaminants such as oils, mineral salts and suspended particulates. During the cleaning stage of the cleaning process, contaminants are removed from the articles by contact between a cleaning solution and the articles. As these contaminants are removed from the articles and introduced into the aqueous cleaning solution, the aqueous cleaning solution may become too concentrated with contaminants to perform adequately. Contaminants that reduce the effectiveness of the cleaning solution include organic components, such as free floating and emulsified oils, and inorganic materials including mineral salts or suspended particulates. Other materials, which are inherent to the cleaning chemistry, may also concentrate over time and decrease the effectiveness of the cleaning solution.

Aqueous based cleaning solutions that have been used to clean soiled articles may contain from 1 to 5% emulsified oils and up to 50% free floating oils, depending upon the articles being cleaned and the effectiveness of the solutions. A greater amount of the oils may also be present in the solutions. These “used” solutions are hereafter referred to as soiled cleaning solutions. The prior art discloses methods of treating the soiled cleaning solutions to remove the contaminants contained therein. Treatment of such soiled cleaning solutions, however, can be impractical for small waste generators and costly for large waste generators. Classical treatment methods for soiled aqueous based cleaning solutions include decanting, skimming, and coalescing. These treatment methods are useful for removing large amounts of free floating oil contaminants, but are not effective for removing emulsified oil contaminants.

Emulsified oil as well as free floating oil may be removed from soiled cleaning solutions via membrane filtration. The act of removing contaminants from the aqueous cleaning solution via membrane filtration is known as cleaner recycling. An aqueous cleaning solution is considered recyclable if the contaminants contained therein can be removed in a sufficient proportion such that the cleaning solution may be effectively reused in the cleaning process. Typically, a recycling process using membranes will trap solids, free floating oils, and emulsified oils while passing some surfactant, alkalinity builders, other adjuvants and water back into the aqueous cleaning solution.

Recycling by membrane filtration, therefore, not only reduces or eliminates the discharge of contaminated water into the environment, but it also allows the aqueous cleaning solution to be used for an extended time frame. An effective recycling process, therefore, results in economic and environmental advantages for the user.

Membrane filtration typically involves a pressure driven process that will remove particles and oil from the soiled cleaning solutions. Several types of membrane processes are used in the industry, including ultrafiltration and microfiltration. The major problems with membrane filtration involve cost, chemical fouling, scaling and membrane compatibility. In addition, active cleaning components are often removed via membrane filtration resulting in a less effective permeate. Furthermore, prior art membrane filtration processes are limited to lower temperatures since higher temperatures detrimentally affect cleaning, foaming and anti-corrosion properties of the cleaning solutions. The effectiveness of the prior art recycled compositions as well as their length of use, therefore, are substantially reduced. The invention that is described below overcomes these prior art limitations.

As indicated above, high surfactant permeability is required for the effective recycling of soiled cleaning solutions. High surfactant permeability is defined as the ability of the surfactant to maintain 50% by weight (or greater) of its starting value upon recycling in unsoiled conditions and to maintain 30% by weight (or greater) of its starting value upon recycling in soiled conditions. The identification of surfactants with high surfactant permeability may be attained by known methods. However, the known methods of measuring surfactant permeability are very time consuming and considerable analytical effort is required to support these permeability measurements. Given the large number of available surfactants, an alternative approach is needed to identify surfactant candidates likely to have high surfactant permeability. The invention that is described herein provides this identification

Much has been disclosed in the literature concerning the filtration of aqueous cleaning solutions. U.S. Pat. No. 5,205,937 to Bhave et al. discloses aqueous cleaning systems wherein a high percentage of the cleaner is said to pass through to the permeate for recycling. The amount of cleaner in the permeate, however, is measured by alkalinity titration. In fact, most of the nonionic surfactants disclosed therein do not pass through the membrane.

U.S. Pat. No. 5,654,480, U.S. Pat. No. 5,843,317 and U.S. Pat. No. 5,919,980 all to Dahanayake, et al., U.S. Pat. No. 6,004,466 to Derian et al., and U.S. Pat. No. 6,013,185 to Ventura, et al. Claim improved surfactant recovery upon ultrafiltration of surfactant containing aqueous solutions. The degree of recycling and recovery in these patents was determined by comparing the surface tension of permeate and feed streams. This method of measurement, however, is qualitative and raises technical issues on the validity of the results.

For example, any soil introduced into the system could effect the nature of the surface tension curve in the area between critical micelle concentration (CMC) and infinite dilution. In addition, it is well known that surfactant systems are comprised of a variety of oligomers and selective partitioning of some oligomers will effect the CMC resulting in possible significant error. In this case, CMC measurements to determine surfactant concentration would be invalid. In addition, this prior art is silent on determining recyclability in the presence of soil.

To determine the actual recyclability of surfactant systems, the surfactant system must be tested in the presence of soil. It is well known in the art that surfactant are composed of several oligomers (polydisperse, hydrophobe, and lipophobe) which behave differently in their partitioning between oil and water phases. For instance, a typical nonionic surfactant having a reported HLB (hydrophobic/lipophobic balance) of 12 will, in fact, contain a range of components having HLB from about 4 to 14. The hydrophobic/lipophobic balance (HLB) values measure hydrophobicity and are used to characterize surfactants for their water/oil solubility. Therefore, in the application of recycling in the presence of soil, the low HLB surfactant components will naturally be eliminated due to the higher partitioning of these materials into the rejected oil phase. Thus, the presence of soil must be considered in the identification of optimum and unique systems for recycle use.

Woodrow, et al., Metal Finishing, November 1998, discusses a case study in the regeneration of a soiled aqueous cleaner using ultrafiltration. In this study, the recycled cleaners were measured and compared in connection with refractive indexes, solution pH and conductivity of permeate of feed solutions as well as gravimetric determination of surfactants. It was determined that filtration reduced oils below 0.01% but also significantly reduced the amount of active cleaning ingredient in the permeate.

The literature references referred to in this disclosure are incorporated herein in their entirety.

An object of the invention is to provide a recyclable cleaning composition and process for removing contaminants from hard surface articles where a membrane system is employed to treat the soiled cleaning solution whereby the membrane will reject hydrophobic oily contaminants contained in the soiled cleaning solution while allowing the active ingredients of the cleaning solution to permeate the membrane for reuse.

A second object of the invention is to provide an aqueous waste cleaning system for removing contaminants from hard surface articles where a membrane system is used to treat the soiled cleaning solution, the permeate retains a high degree of active cleaning constituents and where the membrane used therein has a pore size range from about 0.05 to about 5 microns.

A third object of this invention is to provide a method for rapidly screening surfactants for permeablilty.

These and other objects of the invention will become readily apparent upon consideration of the following detailed description of the invention, taken in connection with the accompanying drawings.

### SUMMARY OF THE INVENTION

It has been surprisingly found that increased surfactant recovery can be obtained via a filtration process using aqueous compositions containing certain surfactant systems which, when filtered, result in a permeate having increased surfactant concentrations as compared to the prior art. The recyclable cleaning compositions of the present invention comprise an aqueous alkaline solution containing from 1% to 20% by weight of a synthetic detergent comprising at least one surfactant, and a high degree of permeability through a membrane having a pore size of about 0.05 to about 5.0 microns after the composition has been used in the cleaning process.

The cleaning composition may optionally contain builders, corrosion inhibitors, anti-scaling materials, alkalinity electrolytes, hydrotropes, antifoam materials, wetting agents, solvents and other adjuvants and these adjuvants are also permeable through the membrane for recycling and reuse. The cleaning composition also can be used at low concentrations while imparting good cleaning and low foaming profiles.

The present invention also provides a process for the filtration of contaminants from an aqueous surfactant containing composition by passing the soiled cleaning solution through a membrane having a pore size of about 0.05 to about 5.0 microns where the contaminants are filtered off and the permeate contains a high level of cleaning agents and is recycled for reuse.

The present invention also provides a method for rapidly screening surfactants for permeability.

### BRIEF DESCRIPTION OF THE DRAWINGS

FIG. 1 is a schematic representation of the recycle system of the present invention.

FIG. 2 is a graph showing membrane pore size versus percent recyclability for Formula A versus Formula B in unsoiled condition at 80° F.

FIG. 3 is a graph showing membrane pore size versus percent recycliability for Formula A versus Formula B in unsoiled condition at 140° F.

FIG. 4 is a graph showing membrane pore size versus percent recycliability for Formula A versus Formula B in soiled conditions at 80° F.

FIG. 5 is a graph showing membrane pore size versus percent recyclability for Formula A versus Formula B in soiled condition at 140° F.

FIG. 6 is a graph showing the HPLC Log P Calibration Curve (alkyl benzene standards).

FIG. 7 is a graph showing HPLC Profiles of Neodol® 91-6 and of Poly-Tergent® SL-92.

FIG. 8 is a graph showing Calculated vs. Estimated Surfactant Log P Results.

FIG. 9 is a graph showing Permeability Results in unsoiled conditions.

FIG. 10 is a graph showing Neodol® 91-6 Hydrophobe Permeability Results in unsoiled conditions.

FIG. 11 is a graph showing Poly-Tergent® SL-92 Hydrophobe Permeability Results in unsoiled conditions.

FIG. 12 is a graph showing Surfactant Permeability vs. Log P in unsoiled conditions.

FIG. 13 is a graph showing Surfactant Permeability vs. Cloud Point in unsoiled conditions.

FIG. 14 is a graph showing Permeability vs. Log P for all hydrophobes in unsoiled conditions.

FIG. 15 is a graph showing Permeability vs. Log P for unsoiled conditions at 140° F. for all hydrophobes.

FIG. 16 is a graph showing permeability results of surfactants in the presence of Cosmoline® 1102.

FIG. 17 is a graph showing permeability results of Neodol® 91-6 in the presence of Cosmoline 1102.

FIG. 18 is a graph showing permeability results of Polytergent® SL-92 the presence of Cosmoline 1102.

FIG. 19 is a graph showing Permeability vs. Cloud Point for Cosmoline® 1102 Soil at 140° F.

FIG. 20 is a graph showing Permeability vs. Log P for Cosmoline® 1102 soil at 140° F. for all hydrophobes.

FIG. 21 is a graph showing Permeability vs. Cloud Point for Pennzoil® 4096 Gear Lubericant SAE 80W90 GL5 soil at 140° F.

FIG. 22 is a graph showing Permeability vs. Log P for Pennzoil® 4096 Gear Lubericant SAE 80W90 GL5 soil at 140° F. for all hydrophobes.

FIG. 23 is a graph showing Permeability vs. Log P for Pennzoil® 4096 Gear Lubericant SAE 80W90 GL5 soil at 140° F. for all hydrophobes.

FIG. 24 is a graph showing Permeability Results—Unsoiled vs. Pennzoil® 4096 Gear Lubericant SAE 80W90 GL5 soil.

FIG. 25 is a graph showing permeability result of Barlox® 12i Multiple Oil Addition Study

FIG. 26 is a graph showing Temperature Effect on Permeability Results—Cosmoline® 1102 Soil.

### DETAILED DESCRIPTION OF THE INVENTION

The objects and advantages mentioned above as well as other objects and advantages may be achieved by the compositions and methods hereinafter described.

The recyclable cleaning compositions of the present invention are useful in the cleaning of hard surface articles such as metal, glass, plastic, ceramic or other hard surface articles. The recyclable cleaning compositions of the present invention are designed to clean hard surface articles by lifting soil and contaminants from the articles and preventing redeposition of said soils and contaminants.

The cleaning compositions of the present invention are designed to be used in a variety of cleaning machines including, but not limited to, hand parts washers, immersion dip baths, power spray systems, ultrasonic baths, and spray wands.

The recyclable cleaning compositions of the present invention comprise an aqueous alkaline solution containing a detergent comprising certain classes of individual surfactants and their mixtures, that when combined with other formulation ingredients, such as builders, corrosion inhibitors, antiscaling materials, alkalinity electrolytes, hydrotropes, antifoam materials, wetting agents and other adjuvants, provide unique cleaning compositions that demonstrate improved recycling capabilities as well as high utility in terms of cleaning, foaming and surface protection.

Important to the present invention is the choice of surfactants which allow the present invention to provide a high degree of cleaning and also provide a high degree of permeability when tested with various membranes ranging in pore size from 0.05-5.0 microns. A high degree of permeability means that at least 50% by weight of the surfactant in the solution permeates a membrane having a pore size of about 0.05 to 5.0 microns in unsoiled conditions, and at least 30% by weight of the surfactant in the detergent permeates the same sized membrane, after the solution is contaminated or soiled under at least one set of soiled conditions. A preferred set of soiled conditions would include the use of Cosmoline® 1102 from Houghton International, Inc. of Valley Forge, Pa., as the soil with the operating temperature of 140 degrees F. The recyclable cleaning compositions of the present invention comprise a detergent that includes one or more surfactants that have an estimated Log P, as defined below, of less than 4.5. The compositions of the present invention are designed for use at temperatures below about 90° C.

Membranes of all types can be used with this invention including but not limited to those made of ceramic, polysulfone, polyacrylnitrile (PAN), and cellulose.

The formulations of the present invention employ certain classes of individual surfactants and their mixtures, which when combined with other formulation ingredients such as builders, corrosion inhibitors, alkalinity electrolytes, antiscaling materials, hydrotropes, antifoam materials, wetting agents, solvents, other adjuvants and mixtures therof, provide unique cleaning compositions with useful properties of recyclability and waste water clean-up as well as providing high utility in terms of cleaning, foaming and surface protection.

The formulations of the present invention may also contain water which dilutes the aqueous alkaline solution of the present invention.

The recyclable industrial cleaning compositions of the present invention are an improvement over the prior art at least because the compositions of the present invention may be freed of contaminants via filtration over a wide range of temperatures while retaining a significant amount of their cleaning components under soiled conditions. Moreover, the cleaning compositions may be used at low concentrations and also provide excellent cleaning, low foaming and corrosion protection upon recycle and reuse.

A practical family of formulations which are based on a combination of surfactants and builders and other adjuvants which meet a technical criteria for permeabilities to specific membrane pore sizes are disclosed herein.

Recycle System Process Description

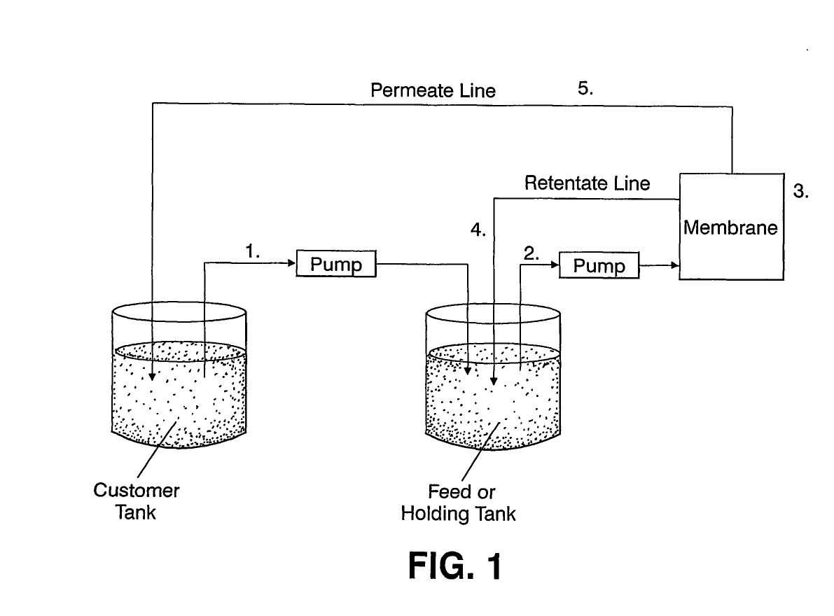

FIG. 1 depicts a schematic view of one type of recycle system process. As can be seen from FIG. 1, the original cleaning composition is contained in an initial tank, called a customer tank, and is pumped to a holding tank where soiled articles are present. After cleaning of the articles, the soiled cleaning solution is then pumped from the holding tank and through a membrane. The soiled cleaning solution then flows across the membrane and the components that are too large to permeate the pores of the membrane are separated from the solution. The separated material is called the retentate. The retentate is returned to the holding tank as depicted, although the retentate may also be discarded. The solution that passes through the membrane is called the permeate. The permeate is returned to the customer tank for reuse.

The permeability of surfactant containing compositions may be measured by preparing a two liter sample of a test solution containing at least one surfactant and heating it to the temperature for the study. The test solution is placed in a test solution container. The test solution is fed into a standard cross flow membrane of pore size and material of construction of choice for the study. The permeate solution is collected and the retentate stream is recycled back into the test solution container. The test continues until 90% of the original two liter test solution volume in the container has been consumed. Analyses for active components (e.g., surfactants) are then compared between the original test solution, the retentate and the permeate. The % permeability of surfactant containing compositions is calculated using the equation below.

The % permeability is defined as

$$\% permeability = \frac{{concentration}_{( permeate )}}{{concentration}_{( initial )}} * 100$$

Results can easily be obtained by measuring the total organic carbon content (TOC), among other tests.

The Temperature of Operation and HLB

The range in temperature for cleaning hard surface articles, called the operating temperature, generally is from about 111° F. to about 181.4° F. (about 44° C. to about 83° C.). The choice of surfactant system for the aqueous cleaning composition depends upon the behavior of the surfactant system in water as a function of temperature. As the temperature increases, surfactants generally tend to become insoluble and ineffective for recycling. The point at which a surfactant becomes insoluble and precipitates or “clouds out” is called its cloud point.

Without being held to any theory, it is believed that when nonionic surfactants are mixed in aqueous systems, the surfactant becomes solubilized by forming hydrogen bonds with the surrounding water molecules thereby becoming hydrated. As the temperature of the system is increased, the surfactant/water hydrogen bonds are broken and the surfactant becomes dehydrated. When the surfactant becomes dehydrated, it has reached its cloud point. At its cloud point, a surfactant becomes insoluble in water but highly soluble in oil.

Surprisingly, it has been found that it is difficult to judge permeability based solely on cloud points. For example, Table A shows that Poly-Tergent® E-17A, an ethylene oxide-propylene oxide-ethylene oxide (EO-PO-EO) block copolymer made by BASF Corp. of Mt. Olive, N.J., has roughly the same permeability (based on total organic carbon) of Poly-Tergent® SL92, a linear alcohol alkoxylate, at room temperature (68° F.) despite the wide difference in cloud point.

Similarly, surfactant hydrophobicity would be expected to determine the degree to which soil partitioning occurs. The hydrophobic/lipophobic balance (HLB) values measure hydrophobicity and are used to characterize surfactants for their water/oil solubility. HBL values, however, do not lend themselves well to estimating permeability in connection with small pore membranes, as can be seen in Table A which shows that Poly-tergent® E-17A, has roughly the same permeability (based on total organic carbon) of Poly-tergent® SL92, despite the wide difference in HLB.

TABLE A
% Permeability and Cloud Point

| Surfactant | Permeability (% TOC) | cloud point F° | HLB | MW |
|---|---|---|---|---|
| Poly-tergent | 55 | 32 | 2.4 | 2500 |
| E-17A | | | | |
| Poly-tergent | 53 | 92 | 12.9 | 850 |
| SL-92 | | | | |

The Composition

Important to this invention is the choice of surfactant or surfactants for the cleaning compositions. The surfactants of this invention allow the disclosed formulations to provide a high degree of cleaning as well as a high degree of recyclability. The cleaning compositions contain from 1% to 20% by weight of a synthetic detergent. The detergent comprises a surfactant or surfactants selected from amine oxide surfactants, nonionic ethoxylated surfactants, anionic surfactants, alkyl polyglucoside surfactants, amphoteric surfactants and mixtures thereof, wherein at least one of the surfactant or surfactants have a Log P of less than 4.5 as determined by the method set forth herein.

The octanol/water partition coefficient is a common measure of hydrophobicity used for environmental and pharmaceutical applications. Because of the large range in values, octanol/water partition coefficients are typically reported as Log K_{ow}, also known as Log P. This measurement is calculated by the following equation:

$$Log P = Log \frac{( {conc}_{octanol} )}{( {conc}_{aq} )}$$

The preferred amine oxide surfactants are those with an alkyl chain length of from about C₈ to C₁₂. Amine oxide surfactants of this type are available commercially under the name Mackamine® (alkyldimethyl amine oxide) manufactured by McIntyre Chemical of Chicago, Ill. and Barlox® 12i (proprietary dimethyl amine oxide) manufactured by Lonza Inc. of Fairlawn, N.J.

The preferred nonionic ethoxylated surfactants include capped alkyl ethoxylates, alcohol ether carboxylates and alkoxylated amine surfactants. Commercially available alkyl ethoxylates of this type include Neodol® 91-6 manufactured by Shell Chemical Co. of Houston, Tex., Poly-Tergent SL-92 manufactured by BASF Corp. of Mt. Olive, N.J., Triton® RW100, Triton® SP-190 by Union Carbide of Charleston, S.C.

The preferred anionic surfactants include sodium dodecylbenzene sulfonate, sodium alkyl sulfate, sodium alkyl phosphate esters, sodium alkyl ether sulfates, and others. A commercially available surfactant of this type is Avanel®S74 from BASF Corp. of Mt. Olive, N.J.

The alkylpolyglucoside surfactants are commercially available such as Glucopon® 425 manufactured by Henkel Corp. in Ambler, Pa. and Triton® CG110 by Union Carbide of Charleston, S.C.

The preferred amphoteric surfactants include sultaines, betaines, imidazole derivatives, alkylaminoproprionate and diproprionates. Commercially available examples of amphoteric surfactants are Mirataine® JC-HA manufactured by Rhodia, Inc., Foamtaine® CAB-A by Alzo, Inc. of Sayerville, N.J. and Amphoteric® 400 from Tomah Products of Milton, Wis.

The present invention may also contain adjuvants as described below.

The present invention may contain builders such as alkali earth metal and/or ammonium salts of carbonate, bicarbonate, hydroxides, phosphates, and silicates or mixtures thereof for the purpose of providing a builder system, and to provide buffering and/or pH adjustability. Other optional ingredients that provide buffering and pH adjustability include potassium hydroxide, sodium hydroxide and simple amines such as triethanolamine and 2-(2-aminoethyl)-ethanol.

A preferred embodiment of the present invention contains a blend of potassium carbonate and potassium bicarbonate. A preferred range of this blend is a ratio of 1/20 to 20/1 and the preferred weight percent of this blend is about 2 to 15 weight percent of the composition. A more preferred blend ratio is 1/2 to 2/1 and a more preferred weight percent is about 7 to 12 weight percent.

Use of corrosion inhibitors such as borax, benzotriazole or carboxylic acid amine mixtures may be included to protect the soiled hard surface articles from flash rusting. The preferred weight % of corrosion inhibitors is 0.1 to 8 weight percent of the composition. Cobratec® TT-100, a benzotriazole, by PMC Specialties in Rocky River, Ohio, is an example of a corrosion inhibitor. Hostocor® 2732 and DeCore® IMT-100LF, carboxylic acid amine mixtures, manufactured and Clairiant Corp. in Charlotte, N.C. and Deforest of Boca Raton, Fla., respectively, are also examples of corrosion inhibitors.

Anti-scaling materials such as acrylic acid, gluconates and phosphonates, in both acid and salt form, may be included to help prevent hard water interference. Hard water interference is manifested in scale formation. These materials also act as sequestering agents. The preferred weight percent of the gluconates and phosphonates is 0.5-5 weight percent of the composition. Commercially available phosphonates include Belcore® 577 and Dequest® from the FMC Corp., Princeton, N.J. and Solutia Inc. of St. Louis, Mo., respectively.

Anti-foam materials such as block copolymers having an HLB of 6 or below, capped alcohol alkoxylates and specialty high molecular weight polymers, such as polysiloxane polymers, can be used to minimize foaming. Preferred weight % of such components range from 0.01 to 5 weight percent of the composition. Commercially available components of this type are Antarox® L-61 of Rhodia, Inc. and T Zap® MC-2 by Trico Technologies of Mundelein, Ill.

Hydrotropes, such as neodecanoic acid and isononanoic acid, may also be added to keep the composition from separating. The preferred weight percent of this ingredient is from about 5 to 25 weight percent of the composition. A preferred hydrotrope is Detrope® SA-45 manufactured by DeForest Chemicals of Boca Raton, Fla.

Wetting agents may also be used in the compositions. The preferred weight percent of this ingredient is from about 1 to 10 weight percent. A preferred wetting agent is Surfadone® LP100 from ISP in Wayne, N.J.

Solvents such as methyl, butyl, and propyl glycol ethers and diethers in their ethylene, diethylene, propylene and dipropylene form, as well as alcohols, such as isopropyl, methyl and ethyl alcohol, may also be used to improve the cleaning performance. The preferred weight percent of this component is 1-15 weight percent. Dowanol® DPnB from Dow Chemical is a commercially available product of this type.

The present invention may also contain additional surfactants such as Nonidet® SF-3, an anionic surfactant from Tomah Products of Milton, Wis., Plurafac® LF 1200 of BASF Corp. of Mt. Olive, N.J., Triton® SP-190 and Triton® DF20 by Union Carbide of Charleston, S.C., and Antarox® BL-225 by Rhodia, Inc. of Cranbury, N.J., all of which have a Log P of greater than about 4.5.

The present invention also includes a diluted cleaning composition comprising the cleaning composition and additional water where the additional water is present up to 99.5% by weight of the diluted composition Tables B-D set forth preferred formulations of the present invention.

TABLE B
Formula 1

| Component | Wt. % |
|---|---|
| K₂CO₃ | 8.0 |
| Belcore ® 577 | 1.0 |
| Cobratec ® TT-100 | 0.50 |
| Borax | 0.50 |
| Sodium Silicate | 6.00 |
| KOH | 2.83 |
| Detrope ® SA-45 | 12.00 |
| Triton ® RW 100 | 1.25 |
| Water | QS |

TABLE C
Formula 2

| Component | Wt. % |
|---|---|
| Triethanolamine | 3.0 |
| Belcore ® 577 | 1.0 |
| Cobratec ® TT-100 | 0.3 |
| Detrope ® SA-45 | 10 |
| Foamtaine ® CAB-A | 3.0 |
| Triton ® RW-100 | 2.0 |
| Water | 80.75 |

TABLE D
Formula 3

| Component | Wt. % |
|---|---|
| Triethanolamine | 3.0 |
| Belcore ® 577 | 0.58 |
| Cobratec ® TT-100 | 0.58 |
| Ammonium bicarbonate | 0.5 |
| T Zap ® MC-2 | 0.075 |
| Triton ® RW 100 | 2.0 |
| Triton ® CG 110 | 3.0 |
| Triton ® SP-190 | 1.0 |
| Detrope ® SA-45 | 10 |
| Water | QS |

The compositions of the present invention provide excellent cleaning, very little foaming and excellent compatibility with varying degrees of water hardness. Studies showing these properties are described below. Cleaning results, foaming results and compatibility with water hardness for Formula 2 (Table C) are set forth below in Tables E, F, and G.

For the cleaning study, aluminum substrates were soiled with three soils—Cosmoline® 1102 from Houghton International, Inc. of Valley Forge, Pa., Pennzoil® 4096 Gear Lubricant SAE 80W90 GL-5 grade from Pennzoil Corporation of Houston, Tex., and Pennzoil® Multi-purpose White Grease 705 from Pennzoil Corporation of Houston, Tex. The soiled substrates were placed in a cleaning tank containing Formula 2. The substrates were agitated for ten minutes at 140° F. The cleaning test was run ten times. The results are shown on Table E and reflect the gravamateric loss of weight of the soil applied to the substrates.

TABLE E
% Loss of Soil Weight

| Cosmoline ® 1102 | Pennzoil ® 80W90 | White Grease 705 |
|---|---|---|
| 95.4 | 80 | 98.2 |
| 100 | 97.9 | 100 |
| 100 | 82.7 | 100 |
| 99.3 | 80.3 | 100 |
| 112 | 74.1 | 100 |
| 100 | 55.8 | 100 |
| 96.6 | 91.6 | 100 |
| 99.3 | 100 | 98 |
| 100 | 82.4 | 50.7 |
| 98.9 | 82.7 | 94.1 |

Formula 2 was also tested for its foaming characteristics. The results of this study are set forth below in Table F. A quantity of Formula 2 was placed in a INTERCONT® Top Loading Parts Washer and heated to 140° F. It was run for ten minutes at a spray pressure of 40 psi. This test was run on three different fresh solutions with the average result set forth below in Table F.

TABLE F

| | 0 min | 5 min | 10 min | 15 min |
|---|---|---|---|---|
| Amt of Foam | 60+ | 43 | 5 | 3 |
| (mL) | 60+ | 1 | 0 | 0 |

The compositions of the present invention provide excellent compatibility with varying degrees of water hardness, as can be seen from the results of the following study. Water samples of varying water hardness were prepared. Formula 2 was diluted to 10% and combined with the water samples and the resulting mixture was allowed to stand for 24 hours. The formation of a precipitate indicates an unstable product. The results are set forth on Table G.

TABLE G

| Hardness of Water (ppm) | Amount of Precipitate |
|---|---|
| 0 | none |
| 100 | none |
| 150 | none |
| 300 | none |
| 500 | none |
| 1000 | none |

Membranes

The ability of a surfactant or surfactants to be recycled is assumed to be affected by the ability of the surfactant to depart the micelle of soil and migrate across the membrane. Without being bound to any theory, the factors that influence migration include stability of the micelle and the ability of the surfactant to permeate through the membrane. The stability of the micelle may to depend both on the surfactant system and the type of soil being dispersed.

Membranes of all types can be used with this invention including but not limited to those made of ceramic, polysulfone, polyacrylonitrile (PAN), and cellulose. Membranes that are slightly hydrophobic are preferred. The PAN membrane with a 0.05 micron pore size is most preferred, such as Part #0567 manufactured by Osmonics Corp., Minnetonka, Minn.

The compositions of the present invention have a high degree of permeability after use and are able to permeate a membrane having a pore size of from about 0.05 to about 5 microns after being utilized in cleaning. Smaller pore sizes will not yield sufficient recovery of surfactant ingredients and larger pore sizes will not reject oily components effectively.

Surfactant Octanol/Water Partition Coefficient

The octanol/water partition coefficient is a common measure of hydrophobicity used for environmental and pharmaceutical applications. Because of the large range in values, octanol/water partition coefficients are typically reported as LogK_{ow}, also known as Log P. This measurement is calculated by the following equation:

$$Log P = Log \frac{( {conc}_{octanol} )}{( {conc}_{aq} )}$$

The permeability of a surfactant may be measured by its Log P or its octanol/water partition coefficient. As discussed above, the % permeability is defined as

$$\% permeability = \frac{{concentration}_{permeate}}{{concentration}_{initial}} * 100.$$

Log P values can be determined by a variety of techniques, such as the standard shaker flask technique, chromatography measurements, and calculation based on chemical structure. Log P values may be estimated from reverse phase HPLC retention data or measured directly.

Log P measurement based on High Performance Liquid Chromatography (HPLC) is automatable. For the most accurate results, the HPLC system is calibrated with structural analogues of the compounds of interest that have known Log P values. This is necessary due to the nature of reversed phase HPLC, a separation technique that is based primarily on the size and structure of the hydrophobe. Because of the proprietary nature of many commercial surfactants, another approach was used to estimate Log P values by referencing the HPLC data to alkyl benzene standards and is described below.

The present invention shows that surfactant Log P values indicate the tendency of a surfactant to distribute from the micelle to the aqueous phase and permeate the membrane. A low octanol/water partition coefficient indicates a higher permeability whereas a higher octanol/water partition coefficient indicates lower degree of permeability. Surfactants having a Log P of greater than 4.5 have a low permeability and will be retained in the retentate and will not be recycled back into the cleaning solution.

Prior art cleaning compositions typically contain surfactants the have a Log P of greater than 4.5. The recyclability of those compositions, therefore, is not adequate. The composition of the present invention, on the other hand, contains at least one surfactant having a Log P value of less than 4.5. Therefore, they have greater permeability than the prior art compositions as well as significantly improved recyclability over the prior art.

In addition to the utility Log P as an indication of recyclable, other physical properties such as critical micelle concentration (CMC) may also indicate recyclability.

Recyclability

In general, inorganic materials are permeable regardless of the temperature of operation. The temperature of operation, however, significantly limits the surfactants that may be used in the cleaning process since temperature affects the cleaning ability and recyclability of surfactants. In addition, the presence of soil will have a significant impact on the recyclability of a given surfactant system.

An aqueous cleaning formulation is defined as being useful for recycling if its surfactant component does not fall below about 50% by weight of its starting value, upon recycling in unsoiled conditions. An aqueous cleaning formulation is defined as being useful for recycling if its surfactant component does not fall below 30% by weight of it starting value upon recycling in at least one set of soiled conditions. As discussed above, the product of this invention, due to its unique formulation, allows the surfactant component to permeate a membrane filter by at least 50% of its starting value in unsoiled condition and at least 30% of its starting value in soiled conditions.

Analysis for active components are compared between the original test solution and remaining retentate and the permeate solutions. Results may be obtained by the following equation which shows the results as a percent of actives found in permeate versus the starting solution.

% Recyclability=Permeate/Feed×100

Studies were run to determine how specific formulas perform in a range of membrane systems and operating temperatures, in soiled and unsoiled conditions. A study was also run to determine the relationship between surfactant permeability behavior, cloud points and Log P. The materials, methods of these studies are discussed below. The results of these studies are set forth in the examples.

Materials and Methods for Examples

The materials and method used for Example 1 are set forth in that section. The materials and methods for Examples 2-7 follow.

Surfactants For Examples 2-7

Nonionic surfactants and ionic surfactants were chosen for their range of structures, cloud points, and expected Log P values. For Examples 2-7, the following surfactants were were chosen: Neodol® 91-6, a mixture of primary C₉, C₁₀ and C₁₁ alcohol ethoxylates with an average ethylene oxide (EO) content of 6.0 moles, was obtained from Shell Chemical Co. (Houston, Tex.). Surfonic® L-108/85-5, a mixture of C₆, C₈ and C₁₀ (C₈ major) alcohol ethoxylates with an average EO content of 5.0 was obtained from Huntsman Corporation (Houston, Tex.). Poly-Tergent® SL-92 and Poly-Tergent® S505-LF, both proprietary primary alcohol alkoxylates, were obtained from Olin Corporation (Stamford, Conn.). Naxel® AAS-98S, a linear alkyl benzene sulfonic acid (LAS), was obtained from Ruetgers-Nease Corporation (State College, Pa.). Foamtaine® CAB-A, cocamidopropyl betaine ammonium salt (45% aqueous solution), was obtained from Akzo Inc. (Sayreville, N.J.). Mackamine® C8 (41% solution) and Mackamine® C10 (30% solution), linear octyl dimethyl amine oxide and linear decyl dimethyl amine oxide, respectively, were obtained from McIntyre Group Ltd. (University Park, Ill.). Pluronic® L-61, an ethylene oxide-propylene oxide-ethylene oxide block co-polymer (EO-PO-EO) with a molecular weight of 2000 daltons and containing approximately 10% EO, was obtained from BASF Corporation (Mount Olive, N.J.). Barlox® 12 (30% solution), dodecyl dimethyl amine oxide, and Barlox® 12i (30% solution), a proprietary branched alkyl dimethyl amine oxide, were obtained from Lonza, Inc. (Fairlawn, N.J.). Glucopon® 425N (50% solution), a mixture of C₈, C₁₀, C₁₂, and C₁₄ alkyl mono- and di-glucosides, was obtained from Henkel Corporation (Ambler, Pa.). Tomah AO-405, a proprietary allyl etheramine alkoxylate, was obtained from Tomah Products (Milton, Wis.). Triton® RW100, an ethoxylated alkyl amine, was obtained from Union Carbide of Charleston, S.C.

Soils

Cosmoline® 1102 was obtained from Houghton International, Inc. (Valley Forge, Pa.). Cosmoline® 1102 was developed for use by the United States military, and is in common commercial use for surface protection of metal parts. It consists primarily of low to moderate molecular weight mineral spirits (boiling point of 157° C.) and contains protective agents for metals.

Pennzoil® 4096 Gear Lubricant SAE 80W90 GL-5 grade (Pennzoil Corporation, Houston, Tex.) was obtained from an automotive supply store. It consists primarily of base oils with additives to achieve the American Petroleum Institute's (API) GL-5 service grade and the Society for Automotive Engineers (SAE) Theological specifications. An SAE 80W-90, API GL-5 oil is one of the most popular gear oils in use, and is considered to be a universal gear oil for car and light truck rear axles.

Pennzoil® Multi-purpose White Grease 705 (Pennzoil Corporation, Houston, Tex.) was obtained from an automotive supply store. It is a lithium type petroleum grease with a National Lubricating Grease Institute (NLGI) #2 grade viscosity. It has a stated operating temperature of up to 260° F. Typical applications include lubrication of conventional brakes, wheel bearings and chassis for passenger cars, trucks, etc.

Reagents

House de-ionized water was generated with a Milli-Q Water System (Millipore Corporation, Milford, Mass.). HPLC grade methanol and HPLC grade ammonium acetate were obtained from Fisher Scientific (Pittsburgh, Pa.). Toluene, ethylbenzene, butyl benzene, hexyl benzene, and octyl benzene were obtained from Sigma-Aldrich Corp. (Milwaukee, Wis.). Potassium carbonate was manufactured by Church & Dwight Co., Inc. (Princeton, N.J.). All materials were used without further purification.

Total Organic Carbon (TOC)

A Sievers 800 Portable Total Organic Carbon analyzer was used for the TOC measurement of aqueous samples (Sievers Instruments, Denver, Colo.). Analysis is based on oxidation with ammonium persulfate and UV light. Reported results are the average of triplicate measurements.

High Performance Liquid Chromatography:

A Hewlett-Packard 1050 series HPLC (Palo Alto, Calif.) consisting of a quaternary pump and autosampler was used for analysis of surfactants. Reversed phase HPLC was performed on all samples. Samples were filtered through Gelman 0.45 um PVDF filters and analyzed. Almost all separations were utilized the following conditions:

Column: Supelcosil LC-18 column, 15 cm×4.6 mm, 5 um particle size (Supelco, Bellefonte, Pa.).

Flow: 1 ml/min. Temperature: ambient Injection Volume: 50 ul Mobile Phase A: 70:30 methanol: water (v+v) with 10 mM ammonium acetate.

Mobile Phase B: 100% methanol.

Gradient Program

| | | | | | |
|---|---|---|---|---|---|
| Time-min. | 0 | 20 | 27 | 28 | 33 |
| % B | 17 | 83 | 83 | 17 | 27 |

Detection was achieved with either a Hewlett-Packard series UV detector set at 275 nm, or a Sedere Sedex 55 (Richard Scientific, Novato, Calif.) evaporative light scattering detector (ELSD). The ELSD was operated at 40° C., with a nitrogen flow rate of 1.8 l/min. A Chromeleon Chromatography Data system (Dionex Corp. Sunnyvale, Calif.) was used to collect and process the HPLC data.

Determination of Log P

The determination of the Log P value, which includes both calculated and estimated, for surfactants is set forth below. The Log P values of the present invention are calculated according to the estimated Log P determination.

Determination of Surfactant HPLC Log P Estimates

A reversed phase HPLC method was used to estimate surfactant Log P values. The HPLC capacity factor, k′, for each material was determined according to the equation:

k′=(t_{R}−t₀)/t₀

where,

t_{R}=component retention time, and

t₀=column void time.

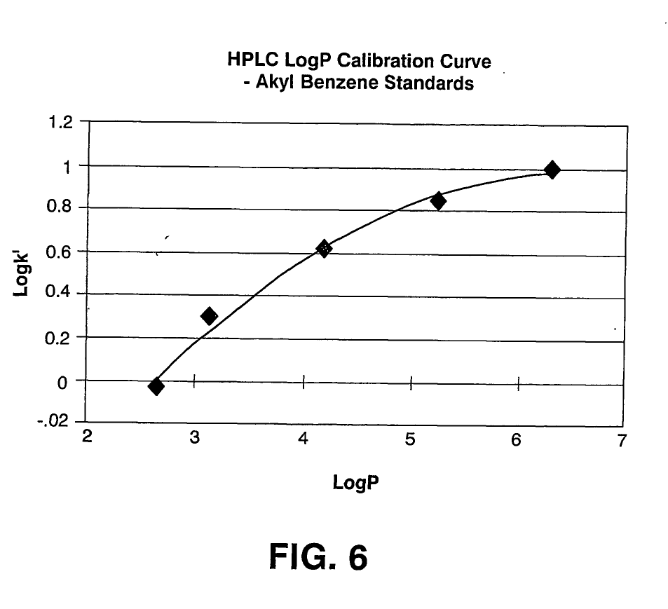

Alkylbenzenes were used as Log P retention time standards: toluene (Log P=2.65), ethyl benzene (Log P=3.13), butyl benzene (Log P=4.18), hexyl benzene (Log P=5.24) and octyl benzene (Log P=6.30). The column void time was determined from the elution time of unretained salt. Under isocratic HPLC conditions, a plot of Log k′ vs. Log P yields a straight line; the plot exhibits curvature under the gradient mobile phase program that was used. (FIG. 6). A quadratic curve results in an acceptable fit of the calibration data, permitting estimates of the surfactant Log P values from the retention data.

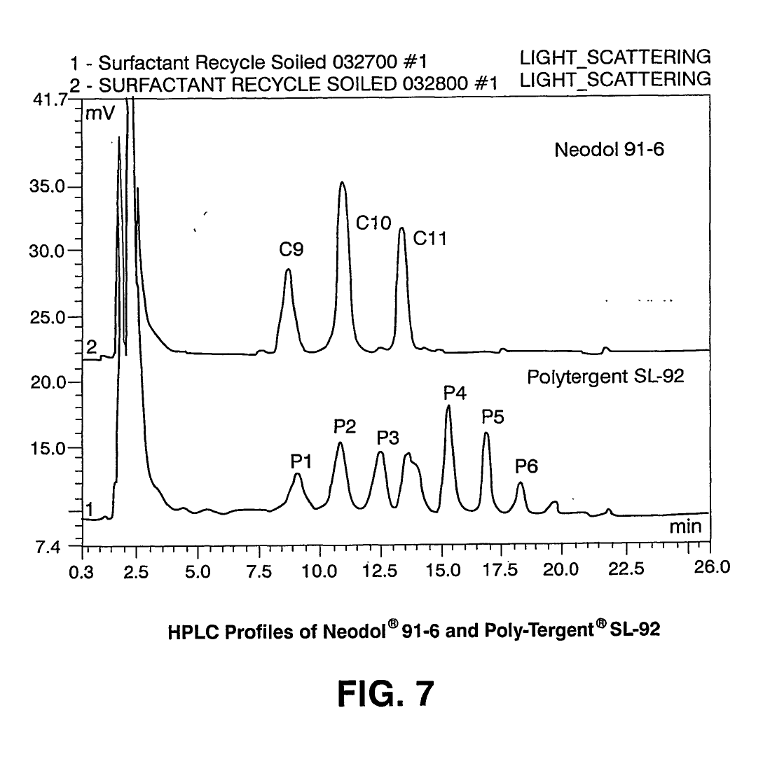

It is well known that many commercial surfactants do not constitute single chemical species, but instead complex mixtures with varying hydrophobes (i.e., alkyl size) and hydrophiles (e.g., level of ethoxylation). The reversed phase HPLC separation used herein separates primarily based on the size of the hydrophobe. The surfactants studied had one of three possible HPLC separation profiles: 1) a single, narrow peak; 2) a single, broad peak; and 3) multiple peaks. The peak maximum retention time was used to determine the Log P estimate for surfactants with either the narrow or the broad single peak profiles. Examples of multiple peak cases are those of Neodol® 91-6 and of Polytergent® SL-92. (FIG. 7). Multiple hydrophobe peaks also occur for the LAS due to decyl benzene sulfonate, undecyl benzene sulfonate and dodecyl benzene sulfonate species; for Surfonic® L108/85-5 for C₆, C₈ and _{c10}hydrophobes; and for Glucopon® 425 which has C₈, C₁₀, C₁₂ and C₁₄ mono-glucosides as major oligomers. The median retention time was used for those surfactants that exhibited multiple peaks under the separation conditions. In addition, the retention time of the individual hydrophobe peaks was used to calculate Log P values for these oligomers. The surfactant Log P estimates are listed in Table H.

Calculated Log P Values

The Log P value of a surfactant can be calculated with reasonable accuracy if the structure is known, as described in the following publications by A. Leo and C. Hansch in “Substituent Constants for Correlation Analysis In Chemistry and Biology,” John Wily, New York (1979) and “Partition Coefficients and their Uses,” Chem. Rev., 71, 525 (1971). This method is based on the concept that the various fragments of a molecule contribute additively to its Log P value. First, the molecule is conceptually divided into fragments. The fragment Log P contributions can be found in published tables. Factors are used to adjust the fragment results, based on the manner in which the fragments are put together to make the molecule.

Some assumptions were used to calculate the Log P values. For each alkyl chain size in the LAS mixture, there exists a distribution of compounds with phenyl substitution at positions along the alkyl chain (i.e., 2-phenyl, 3-phenyl, etc.); the 3-phenyl compound was used to calculate the Log P value for a given alkyl chain size (C10, C11, and C12). Likewise, the alcohol ethoxylates are mixtures of oligomers with an average ethoxylation level reported by the manufacturer; the average EO level was used calculating the Log P value. It was not possible to calculate a Log P value for the amine oxides due to lack of published amine oxide fragment value.

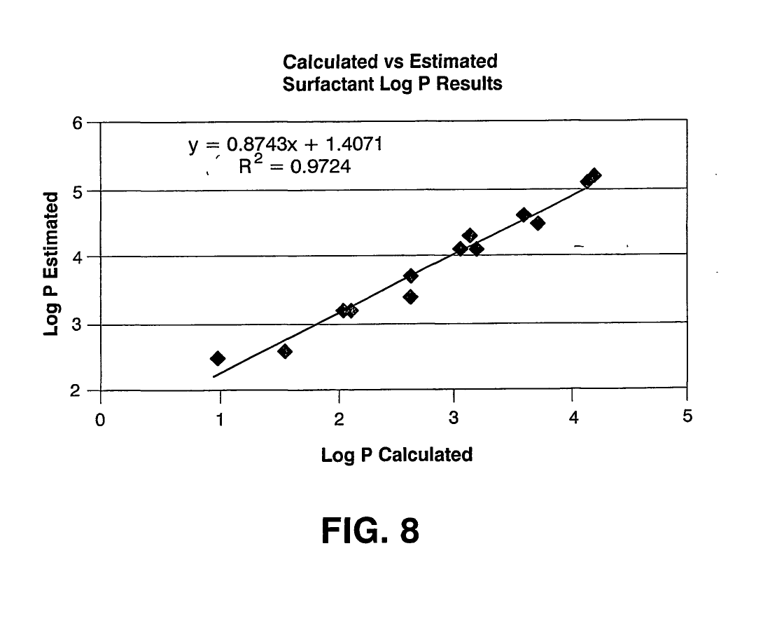

Calculated Log P values are included in Table H for alkyl monoglucosides, linear alkyl benzene sulfonates, and for alcohol ethoxylates. It may be seen that there is a bias between the calculated Log P values and the corresponding HPLC estimated Log P values. The relationship between calculated and estimated Log P values is shown graphically in FIG. 8. Clearly, there is a linear relationship between the two independent approaches to determining Log P. The bias may be due to the choice of alkyl benzenes as HPLC Log P calibration standards. The estimated Log P values could be adjusted using the calculated values as “standards.” However, given the linear relationship between approaches, there is no inherent need to do this. The correlation between the alternative approaches does serve to provide some confidence in the use of HPLC for estimating Log P values for surfactants with unknown structures.

Membrane Filtration Unit Operation

A Membrex Benchmark GX (Fairfield, N.J.) lab-scale rotating membrane filtration unit was used for all permeability studies. Membrane cartridges were made of polyacrylonitrile with a 0.05 um pore size (Part #0567, Osmonics Corp., Minnetonka, Minn.).

Cloud Points

Surfactant cloud point values were obtained from manufacturer literature as reported for 1% aqueous solutions and are reported on Table H.

TABLE H
Surfactants For Permeability Studies

| | Cloud | LogP, | LogP, | |
|---|---|---|---|---|
| | Point | HPLC | cal- | |
| Surfactant | (° C.) | estimate | culated | Comment |
| Mackamine ® C8 | None | 2.5 | | C8 dimethyl amine |
| | | | | oxide |
| Mackamine ® C10 | None | 3.4 | | C10 dimethyl amine |
| | | | | oxide |
| Barlox ® 12i | None | 4.0 | | Proprietary |
| | | | | branched dimethyl |
| | | | | amine oxide |
| Barlox ® 12 | None | 4.5 | | C12 dimethyl amine |
| | | | | oxide |
| Glucopon ® 425N | None | 2.5 | 0.96 | C8 mono-glucoside |
| | | 3.2 (3.8 | 2.0 | C10 mono-glucoside |
| | | median) | | |
| | | 4.3 | 3.1 | C12 mono-glucoside |
| | | 5.2 | 4.2 | C14 mono-glucoside |
| Naxel ® AAS-98S | None | 3.2 | 2.1 | C10 LAS |
| | | 3.7 | 2.6 | C11 LAS |
| | | (median) | | |
| | | 4.1 | 3.2 | C12 LAS |
| Tomah AO-405 | 70 | 4.4 | | Proprietary |
| | | | | branched |
| | | | | alkoxylated ether |
| | | | | amine |
| Foamtaine ® | None | 3.6 | | Cocamidopropyl |
| CAB-A | | | | betaine |
| Surfonic ® | 43 | 2.6 | 1.5 | C6 hydrophobe |
| L108/85-5 | | 3.4 | 2.6 | C8 hydrophobe |
| | | (median) | | |
| | | 4.5 | 3.7 | C10 hydrophobe |
| Neodol ® 91-6 | 52 | 4.1 | 3.1 | C9 hydrophobe |
| | | 4.6 | 3.6 | C10 hydrophobe |
| | | (median) | | |
| | | 5.1 | 4.1 | C11 hydrophobe |
| Poly-Tergent ® | 92 | 4.1 | | Proprietary C6, C8, |
| SL-92 | | | | C10 alcohol |
| | | | | alkoxylate (P1) |
| | | 4.4 | | Proprietary C6, C8, |
| | | | | C10 alcohol |
| | | | | alkoxylate (P2) |
| | | 4.9 | | Proprietary C6, C8, |
| | | (5.2 | | C10 alcohol |
| | | median) | | alkoxylate (P3) |
| | | 5.4 | | Proprietary C6, C8, |
| | | | | C10 alcohol |
| | | | | alkoxylate (P4) |
| | | 5.7 | | Proprietary C6, C8, |
| | | | | C10 alcohol |
| | | | | alkoxylate (P5) |
| | | 5.9 | | Proprietary C6, C8, |
| | | | | C10 alcohol |
| | | | | alcoxylate (P6) |
| Poly-Tergent ® | 47 | 6.2 | | Proprietary C6, C8 |
| S505-LF | | | | C10 alcohol |
| | | | | alkoxylate |
| Triton ® RW100 | 85 | 4.0 | | ethoxylated alkyl |
| | | | | amine |
| Pluronic ® L-61 | 24 | 6.7 | | EO-PO-EO block |
| | | | | copolymer |

The following examples set forth the evaluation of the permeability of various surfactant systems.

As seen through the following examples, a high degree of recyclability resulted from fully formulated compositions of the present invention comprising at least one surfactant having a Log P of less than about 4.5.

It will be understood by those skilled in the art that various modifications may be made in the methods and compositions described above without departing from the spirit and scope of the present invention. Accordingly, it is intended that the specific embodiments described herein are intended as illustrative only, and that the invention is limited only by the claims appended hereto.

### EXAMPLE 1

This Example demonstrates how specific formulas would perform in a range of membrane systems. The study was designed to test specific recyclability factors including formula components (surfactant systems), temperature, membrane pore size, membrane material compatibility and soiled systems versus unsoiled systems.

The original cleaning composition solution was contained in an initial tank (customer tank) and pumped to a holding tank where soiled articles were present. The contaminated cleaning solution was then pumped from the holding tank through a membrane. The contaminated cleaning solution then flowed across the membrane. The retentate was returned to the holding tank. The permeate was returned to the (initial) customer tank for reuse.

The two formulas tested included Formula A which has a surfactant system that is phase stable up to 180° F. and Formula B which has a surfactant system that is phase stable up to 105°-110° F. The formulations for Formula A and B are set forth below on Tables I and J. The formulations were prepare by combining the ingredients listed and mixing at room temperature.

TABLE I
Formula A

| Ingredients | Wt. % |
|---|---|
| Deionized Water | 81.85 |
| 45% potassium hydroxide | 2.65 |
| Potassium bicarbonate | 0.50 |
| Belcor ® 575 | 0.58 |
| Neodecanoic acid | 2.62 |
| Decore IMT-100LF | 5.00 |
| Cobratec ® TT-100 | 0.30 |
| triethanolamine | 3.00 |
| Triton ® DF-20 | 0.50 |
| Avanel ® S-74 | 1.50 |
| Amphoteric 400 | 1.50 |
| Totals | 100.00 |

TABLE J
Formula B

| Ingredient | Wt. % |
|---|---|
| Deionized Water | 75.51% |
| Acrylic acid copolymer | 1.00% |
| Belcor ® 575 | 0.58% |
| Sodium Hydroxide (50 wt. %) Solution | 3.00% |
| Potassium Hydroxide (45 wt. %) Solution | 0.81% |
| Sodium Carbonate | 2.50% |
| Sodium Bicarbonate | 0.25% |
| Sodium Silicate | 2.00% |
| Cobratec ® TT-100 | 0.30% |
| Isononanoic acid | 3.95% |
| Nonidet ® SF-3 | 0.50% |
| Neodol ® 1-73B | 2.00% |
| Poly Tergent ® S505LF | 1.50% |
| Surfadone ® LP-100 | 2.00% |
| BASE Plurafac ® LF-1200 | 1.60% |
| Poly Tergent ® S205LF | 1.50% |
| Pluronic ® L61 | 1.00% |

Two temperatures were tested including 80° F. and 140° F. Seven membrane pore sizes were tested including 50,000 molecular weight cut off, 100,000 molecular weight cut off, 0.05 microns 0.10 microns, 0.20 microns, 0.45 microns and 0.50 microns. Three types of membrane materials were tested including PAN, polysulfone and ceramic. Soiled and unsoiled samples were tested. Soiled systems were tested with 0.5% by volume of ThredKut Light Cutting Oil. The formulations were analyzed by total organic carbon. The total organic carbon values for three samples per experiment were compared. The percent recyclability was determined by the equation

$$\% recyclability = \frac{permeate TOC value}{feed TOC value}$$

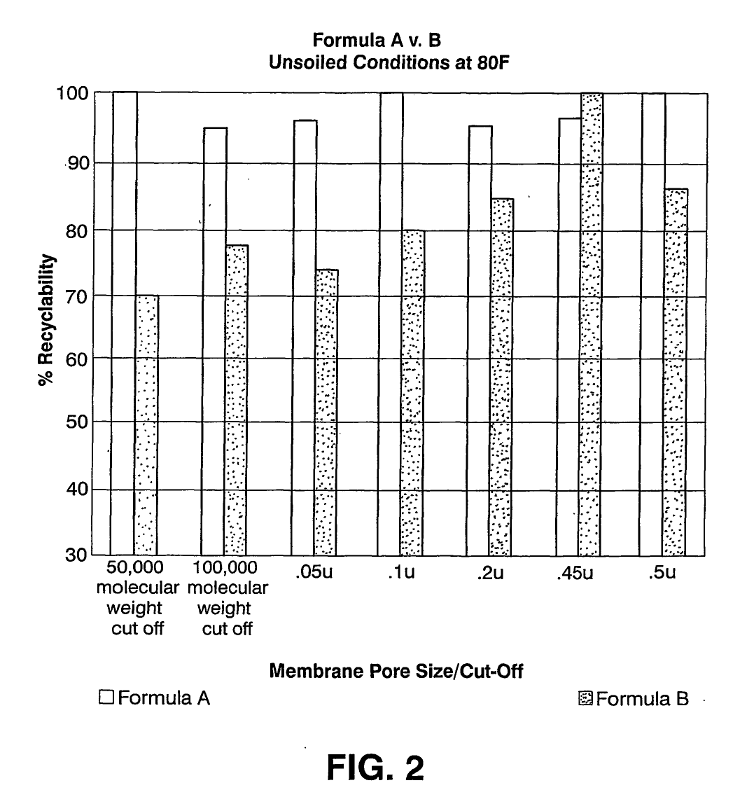

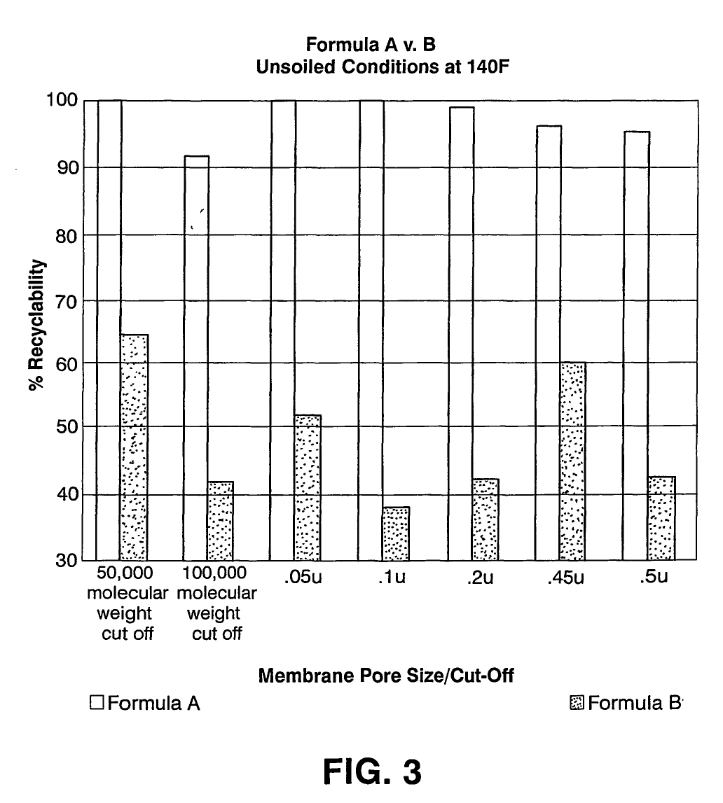

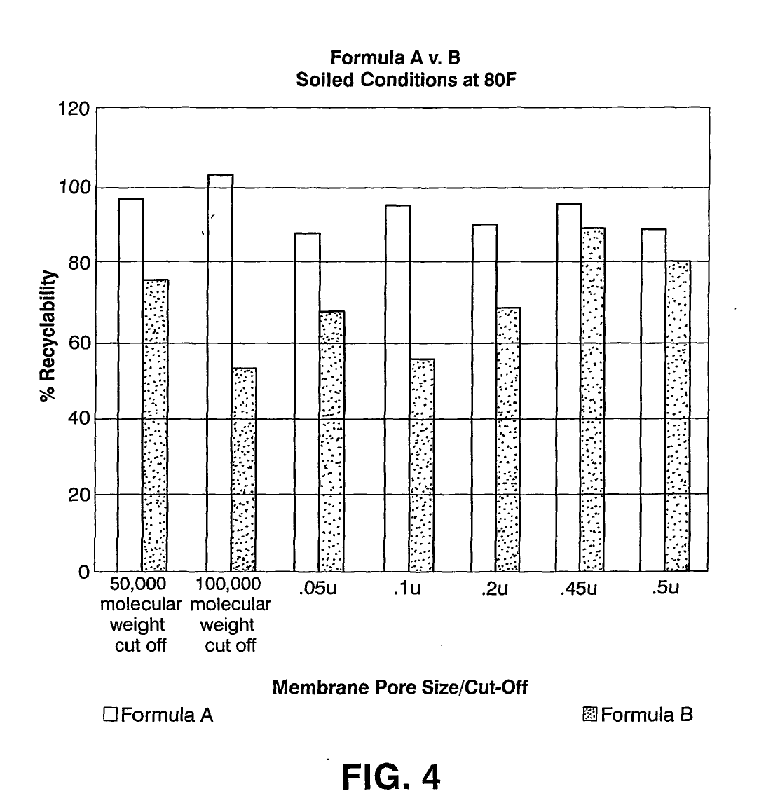

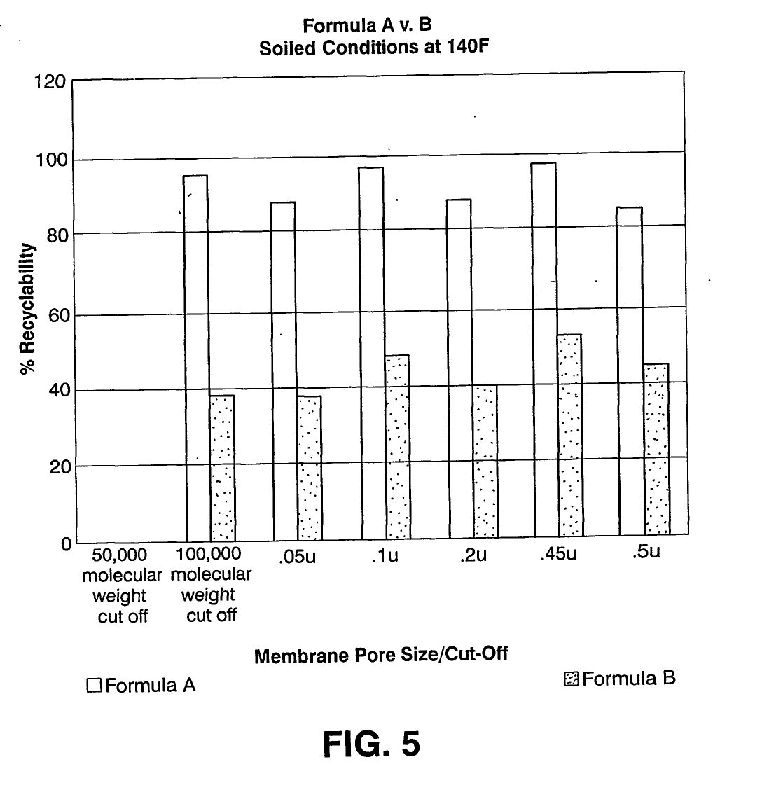

FIGS. 2-5 illustrate the percent recyclability versus membrane pore size for Formula A versus Formula B the in unsoiled and soiled conditions at 80° F. and 140° F.

These experiments indicate that as temperature decreases, recyclability increases, (although if the pore size is too large, soils will permeate the membrane). As soil is introduced, these experiments show that recyclability decreases. Formula A is recycled best at low temperatures and greater than 0.2 micron pore size.

Overall, the two formulas did not exhibit any material compatibility issues. Both formulas seemed to work with all membranes without fouling or degradation. The PAN and polysulfone membranes performed better than the ceramic membrane for the soiled system at 80° F.

### EXAMPLE 2

The surfactants of Table H were evaluated for permeability, both in the absence and in the presence of soil. The surfactants studied were chosen based on their range of cloud points and Log P values. The objective of this work was to determine the relationship between surfactant permeability behavior, cloud points, and octanol/water partition coefficients and Log P.

Example 2 was run in the absence of soil. Results for all samples of Example 2 are included in Table K.

A diagram for the experimental setup is given in FIG. 1. One to two liters of the aqueous alkaline solution of the present invention in its diluted form, usually including 0.15% surfactant and 0.05% potassium carbonate, was placed in both the customer (or initial) and holding tanks (appropriately sized glass beakers). For experiments with soil, oil was added at a 1% level to both tanks. The tanks were heated with magnetic stirring on hotplates to either 140° F. or 100° F. The temperature was maintained throughout each experiment with RTD temperature probes interfaced to the hotplates. The rotation rate of the membrane filtration unit was 3000 RPM. Material from the holding tank was pumped into the membrane filtration unit at a flow of 600 ml/min. The outlet pressure was adjusted to achieve a 5 psi pressure drop across the membrane, resulting in permeate flows of approximately 100-300 ml/min depending on the soil and the operating temperature. The transfer line from the customer tank to the holding tank was adjusted to equal the permeate flow rate in order to maintain a constant level in both customer and holding tank. One cycle or turnover is defined to be the time at which the cumulative volume of permeate equals the initial volume of the customer tank. Permeate samples were collected at 1, 5 and/or 10 cycles.

A 0.05 um PAN membrane was used in the filtration.

Surfactant levels in permeate samples were determined by TOC (unsoiled studies only) and by HPLC/ELSD.

A sample of the initial cleaning solution was collected before addition of oil (if added) and before starting membrane operation. This initial cleaning soultion sample is defined to be the 100% permeable concentration. Serial dilutions of the 100% permeable sample were made to obtain calibration samples for the HPLC analysis. Point-to-point calibration curves were used for HPLC quantitation due to the non-linear nature of the ELSD response. For TOC analysis the initial cleaning solution sample was used for the single point calibration. For surfactants with multiple surfactant oligomers, individual oligomer permeability and overall surfactant permeability were determined. The overall surfactant permeability was calculated from the average of the oligomer results, except for Surfonic® L108/85-5 where the result for major C8 hydrophobe was used.

Overall system reproducibility was evaluated by determining the permeability of Neodol® 91-6 with Cosmoline 1102 oil present on two days approximately one week apart. Between measurements, additional surfactants were evaluated, the membrane was replaced and routine system maintenance performed. Permeability results for the two Neodol® 91-6 runs agreed to <10% relative standard deviation (RSD). System accuracy is estimated to be <20%. The accuracy is affected by the non-linear nature of the ELSD and by potential changes in the ELSD response due to changes in surfactant oligomer distributions (e.g., level of ethoxylation.

The TOC results and the HPLC results are listed in Table K for permeability studies conducted in the absence of soil. In general, there is good agreement between TOC results and HPLC results. The one exception are the results for the Pluronic® EO-PO-EO block co-polymer for which the TOC result is about twice that of the HPLC result. The HPLC results are believed to more reliable as any contamination sources would not be included.

TABLE K
Surfactant Permeability Results in Unsoiled Systems.

| | | % Permeability | % Permeability |
|---|---|---|---|
| Surfactant | Cycle # | (TOC) | (HPLC) |
| Mackamine ® C8 | 1 | 101 | 104 |
| | 5 | 108 | 105 |
| | 10 | 117 | 102 |
| Barlox ® 12i | 1 | 47 | 95 |
| | 5 | 89 | 90 |
| | 10 | 88 | 96 |
| Neodol ® 91-6 | 1 | 45 | 58 |
| | 5 | 47 | 54 |
| | 10 | 54 | 54 |
| Poly-Tergent ® SL-92 | 1 | 66 | 62 |
| | 5 | 67 | 65 |
| | 10 | 57 | 61 |
| Poly-Tergent ® S505-LF | 1 | 56 | 51 |
| | 5 | 54 | 50 |
| | 10 | 57 | 51 |
| Pluronic ® L-61 | 1 | 46 | 20 |
| | 5 | 50 | 21 |
| | 10 | 43 | 23 |

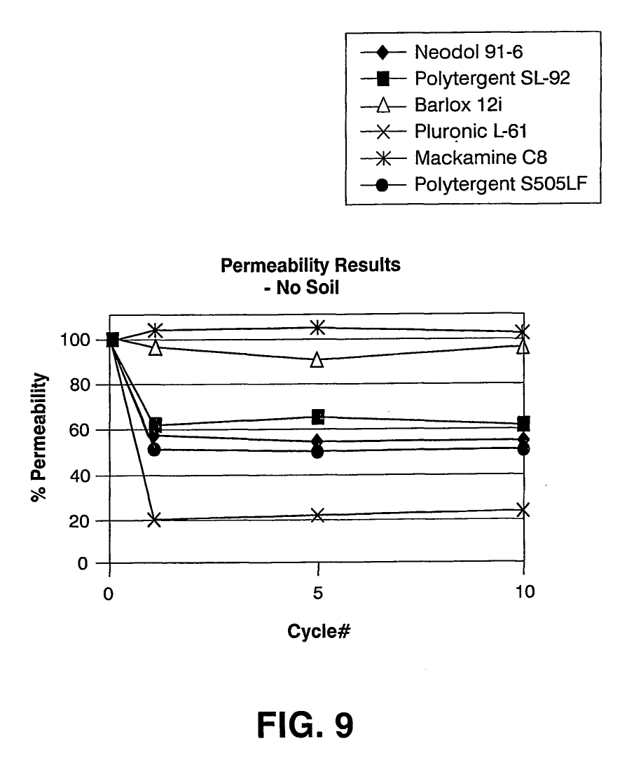

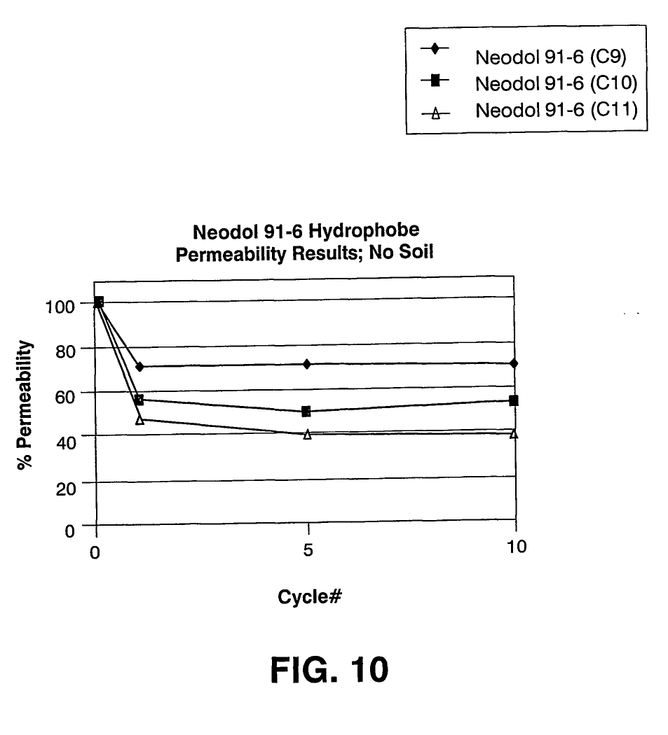

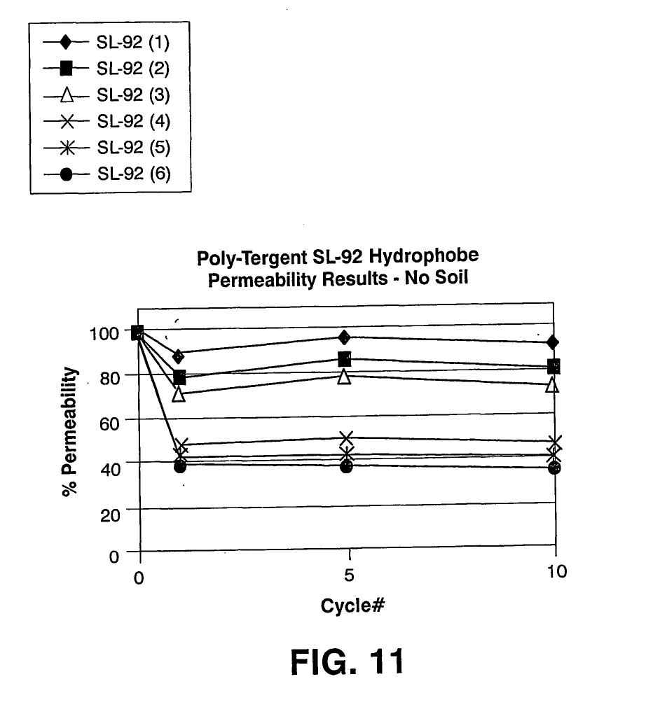

A plot of the HPLC determined permeability results vs. cycle number is shown in FIG. 9. All surfactants evaluated had no significant change in permeability after Cycle 5. Plots of individual hydrophobe results vs. cycle number are given in FIGS. 10-11 and listed in Table L for Neodol® 91-6 and for Poly-Tergent® SL-92 (see FIG. 7 for hydrophobe identifications). The results for the individual hydrophobes are consistent with the lower alkyl size/lower Log P estimate hydrophobes exhibiting greater permeability behavior. For example, the C₉ hydrophobe of the Neodol® 91-6 had a much larger permeability than the C₁₁ hydrophobe.

TABLE L
Unsoiled System Permeability Results
for Surfactant Hydrophobes (HPLC).

| | Cycle #1-% | Cycle #5-% | Cycle #10- |
|---|---|---|---|
| Surfactant/Hydrophobe | Permeability | Permeability | % Permeability |
| Neodol ® 91-6/C9 | 71 | 71 | 70 |
| Neodol ® 91-6/C10 | 56 | 50 | 53 |
| Neodol ® 91-6/C11 | 47 | 40 | 39 |
| Poly-Tergent ® SL-92/P1 | 89 | 96 | 92 |
| Poly-Tergent ® SL-92/P2 | 79 | 86 | 81 |
| Poly-Tergent ® SL-92/P3 | 72 | 78 | 73 |
| Poly-Tergent ® SL-92/P4 | 48 | 50 | 46 |
| Poly-Tergent ® SL-92/P5 | 43 | 43 | 41 |
| Poly-Tergent ® SL-92/P6 | 40 | 38 | 35 |

Unsoiled system data were obtained for additional surfactants for Cycle 5 permeates only. All Cycle 5 results are listed in Table M. Results for individual hydrophobes are included where analysis was possible (Surfonic® L108/85-5, Naxel® AAS-98S and Glucopon® 425N). The individual hydrophobe results are consistent with larger hydrophobe size (and correspondingly larger Log P estimate) exhibiting poorer permeability behavior.

TABLE M
Permeability Results in Unsoiled System (Cycle 5, 140° F.).

| Surfactant | % Permeability |
|---|---|
| Mackamine ® C8 | 105 |
| Barlox ® 12i | 90 |
| Barlox ® 12 | 80 |
| Naxel ® AAS-98S/C10 | 69 (Ave = 62) |
| Naxel ® AAS-98S/C11 | 63 |
| Naxel ® AAS-98S/C12 | 55 |
| Glucopon ® 425/C8 | 104 (Ave = 68) |
| Glucopon ® 425/C10 | 87 |
| Glucopon ® 425/C12 | 44 |
| Glucopon ® 425/C14 | 35 |
| Surfonic ® L108/85-5/C6 | 120 (Ave = 106) |
| Surfonic ® L108/85-5/C8 | 106 |
| Surfonic ® L108/85-5/C10 | 86 |
| Neodol ® 91-6/C9 | 71 (Ave = 54) |
| Neodol ® 91-6/C10 | 50 |
| Neodol ® 91-6/C11 | 40 |
| Poly-Tergent ® SL-92/P1 | 96 (Ave = 65) |
| Poly-Tergent ® SL-92/P2 | 86 |
| Poly-Tergent ® SL-92/P3 | 78 |
| Poly-Tergent ® SL-92/P4 | 50 |
| Poly-Tergent ® SL-92/P5 | 43 |
| Poly-Tergent ® SL-92/P6 | 38 |
| Poly-Tergent ® S505-LF | 50 |
| Pluronic ® L-61 | 21 |

* Ave = overall surfactant permeability based on average oligomer results, except for Surfonic ® L108 for which the C8 oligomer result is used.

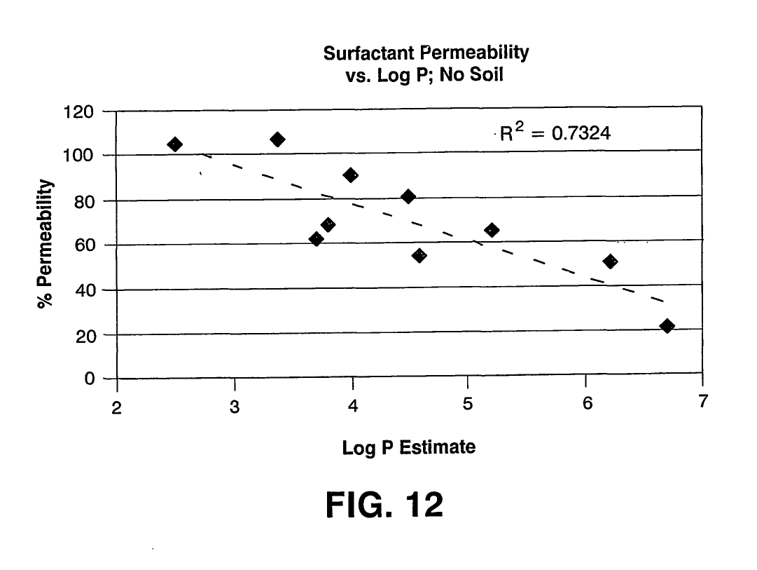

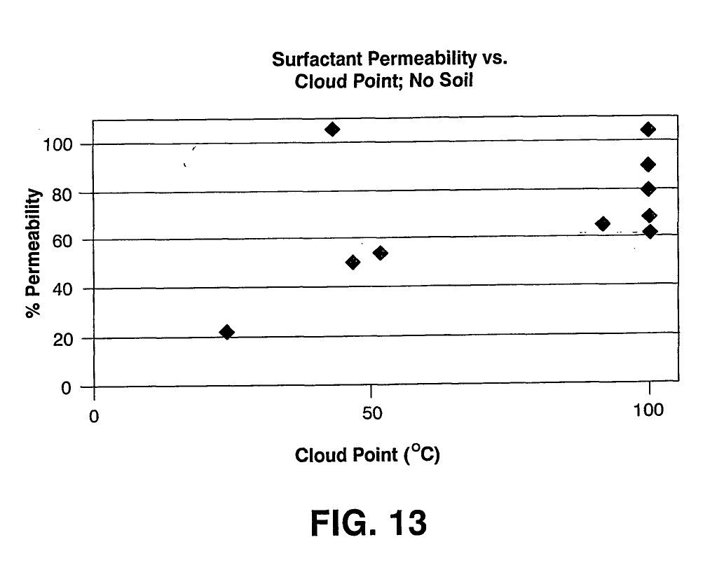

A plot of the HPLC surfactant permeability results for the unsoiled systems vs. Log P estimate is given in FIG. 12. Similarly, a plot of permeability vs. cloud point is given in FIG. 13 (a cloud point value of 100° C. was used for surfactants that do not exhibit a cloud point). A reasonable relationship between permeability and Log P estimate appears to exist based on this data. The relationship between surfactant cloud point and permeability behavior is less clear (FIG. 13). A considerable range of permeability performance was observed for those surfactants that do not exhibit cloud point values (i.e., those plotted at a cloud point of 100° C.).

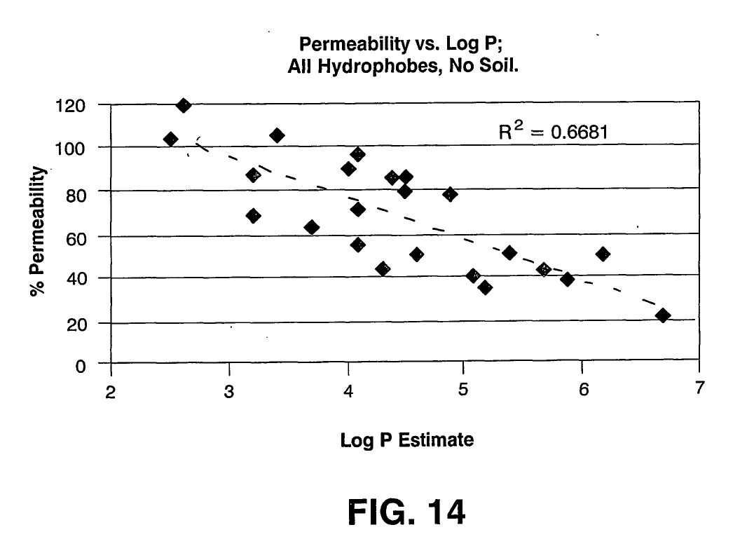

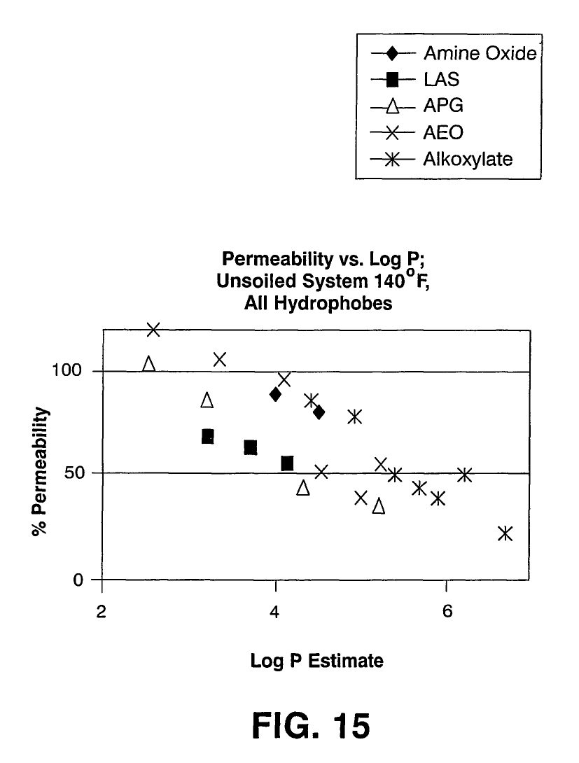

A plot of permeability vs. Log P estimates for all surfactants including the individual hydrophobes is given in FIG. 14. FIG. 15 shows the same plot, but with labels to identify the different classes of surfactant. There appears to be a reasonable correlation between Log P estimate (or hydrophobe size) and % Permeability.

### EXAMPLE 3

Example 3 was performed in the same way as Example 2 but in the presence of soil. The method described in Example 2 was followed in Example 3. The permeability performance of surfactants in soiled systems is of interest given the desire to separate the aqueous cleaning materials from soil. Two oils were evaluated in this study: Cosmoline® 1102 and Pennzoil® 80W90 oil. Observationally, the Cosmoline® oil formed stronger emulsions with the surfactants and exhibited poorer oil/water splitting than the Pennzoil® oil. Depending on the surfactant, samples in the Cosmoline® oil studies tended to have some visible oil observed in the permeates, while no significant oil was observed in the permeates for the Pennzoil® system.

The permeability results determined at 140° F. for the soiled systems are listed in Table N. The Cosmoline® 1102 system initially was evaluated for a small set of surfactants, with permeate samples obtained from Cycles 1, 5, and 10. Of the surfactants studied there was essentially no difference in Cycle 5 vs. Cycle 10 results; the exception is Neodol® 91-6. Based on these results, only Cycle 5 samples were collected and analyzed for the remaining studies reported in Table N.

TABLE N
Soiled System Permeability Results.*

| | Cosmoline 1102- | Cosmoline 1102- | Cosmoline 1102- | Pennzoil80W90- |
|---|---|---|---|---|
| Surfactant/hydrophobe | Cycle 1 | Cycle 5 | Cycle 10 | Cycle 5 |
| Mackamine ® C8 | 94 | 95 | 99 | 95 |
| Mackamine ® C10 | | 53 | | |
| Barlox ® 12i | 41 | 40 | 43 | 98 |
| Barlox ® 12 | | | | 63 |
| Tomah AO-405 | | 30 | | |
| Foamtaine ® CAB-A | | 9 | | |
| Glucopon ® 425/C8 | | 74 (Ave = 29) | | 97 (Ave = 66) |
| Glucopon ® 425/C10 | | 22 | | 77 |
| Glucopon ® 425/C12 | | <20 | | 49 |
| Glucopon ® 425/C14 | | <20 | | 39 |
| Naxel ® AAS-98S/C10 | | 60 (Ave = 41) | | 72 (Ave = 52) |
| Naxel ® AAS-98S/C11 | | 38 | | 52 |
| Naxel ® AAS-98S/C12 | | 26 | | 31 |
| Surfonic ® L108/85-5/C6 | | 91 (Ave = 52) | | 94 (Ave = 82) |
| Surfonic ® L108/85-5/C8 | | 52 | | 82 |
| Surfonic ® L108/85-5/C10 | | 41 | | 56 |
| Neodol 91-6/C9 | 39 (Ave = 39) | 33 (Ave = 32) | 23 (Ave = 16) | 61 (Ave = 38) |
| Neodol ® 91-6/C10 | 30 | 24 | 12 | 32 |
| Neodol ® 91-6/C11 | 47 | 38 | 13 | 20 |
| Poly-Tergent ® SL-92/P1 | 48 (Ave = 38) | 48 (Ave = 38) | 48 (Ave = 38) | 85 (Ave = 70) |
| Poly-Tergent ® SL-92/P2 | 39 | 38 | 38 | 86 |
| Poly-Tergent ® SL-92/P3 | 32 | 32 | 32 | 76 |
| Poly-Tergent ® SL-92/P4 | 31 | 31 | 31 | 61 |
| Poly-Tergent ® SL-92/P5 | 37 | 37 | 37 | 56 |
| Poly-Tergent ® SL-92/P6 | 41 | 42 | 41 | 54 |
| Poly-Tergent ® S505-LF | 17 | 26 | 28 | |
| Pluronic ® L-61 | 19 | 12 | 24 | |

*Ave = overall surfactant permeability based on average oligomer results, except for Surfonic ® L108 for which the C8 oligomer result is used.

As may be seen in Table N, there is a hydrophobe size effect on the permeability results of the C₈, C₁₀, C₁₂, and C₁₄ alkyl mono-glucosides (Glucopon®), the C₈, C₁₀ and C₁₂ alkyl dimethyl amine oxides (Mackamine® and Barlox®), the C₁₀, C₁₁, and C₁₂ alkyl benzene sulfonates (Naxel®), and the C₆, C₈, and C₁₀ alcohol ethoxylates (Surfonic®). The smaller hydrophobes exhibit greater permeability than the larger hydrophobes for a given hydrophile. The prior art regarding alkyl polyglucosides and amine oxides conducted in the absence of soil do not note an effect of hydrophobe size.

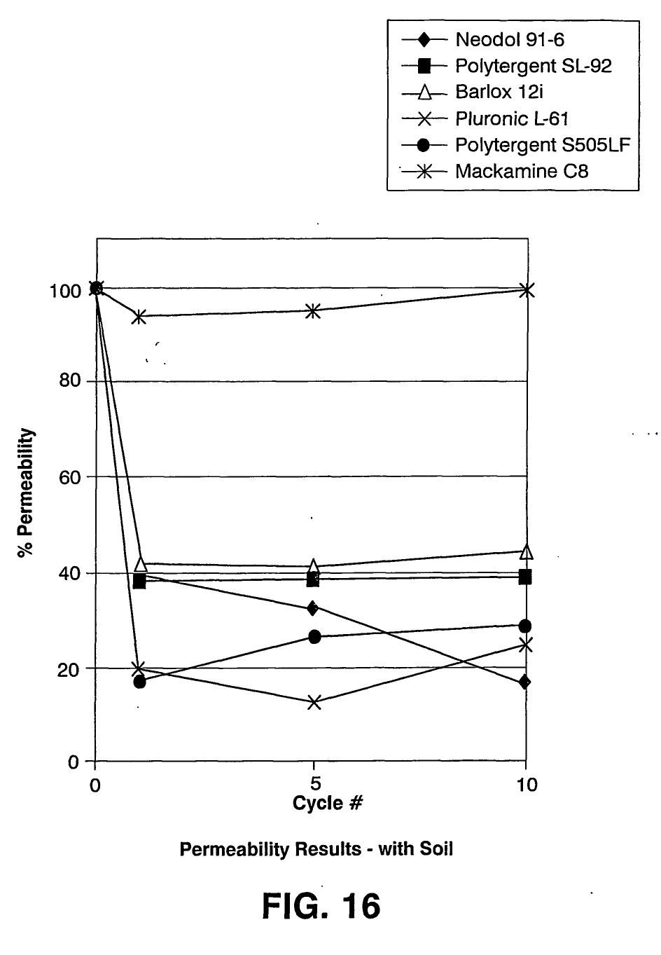

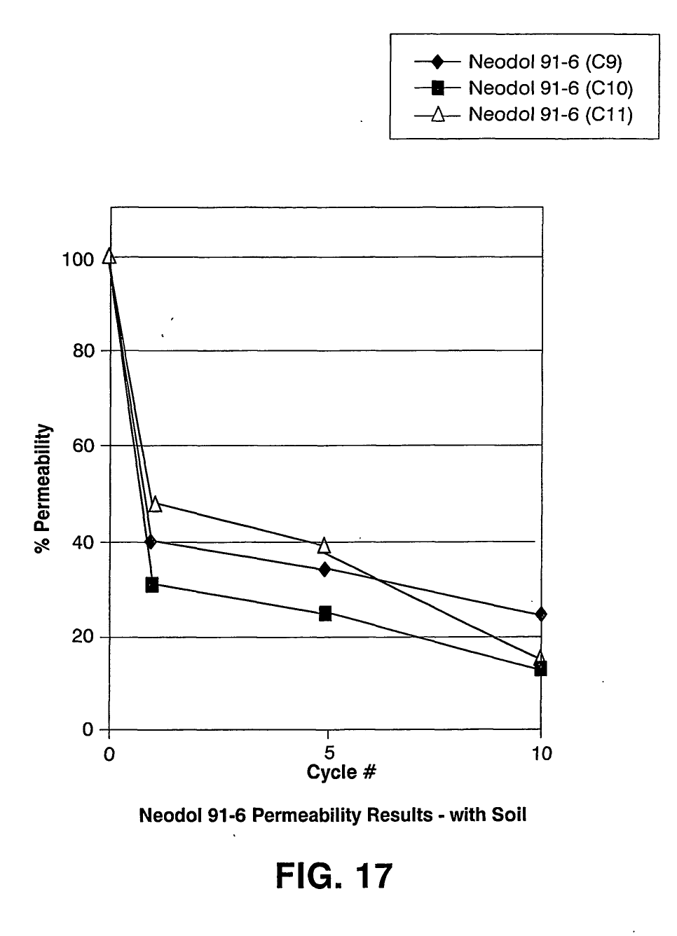

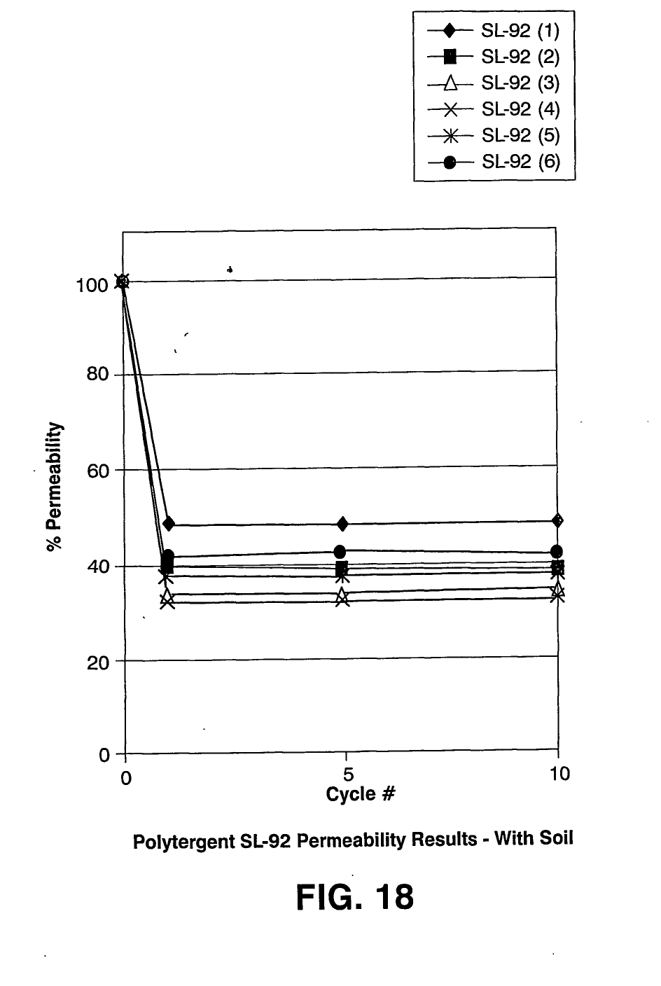

In the Cosmoline® system, there does not appear to be a difference in the permeability results for the various hydrophobes of Neodol® 91-6 and of Poly-Tergent® SL-92 (FIGS. 16-18). These results are unusual considering the large difference in hydrophobe permeabilities observed in the unsoiled system and in the Pennzoil® system. The cause of this alkoxylate hydrophobe “normalization” in the presence of the Cosmoline® soil is not known. However, the permeabilities of both these surfactants are low in the Cosmoline® system when compared to the surfactants that do exhibit the hydrophobe effect.

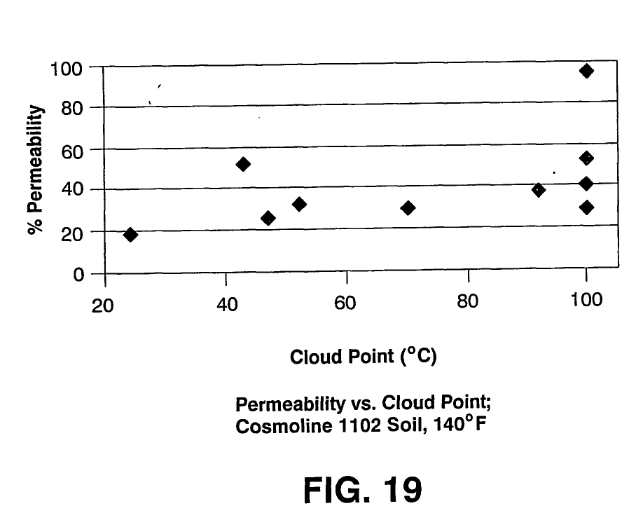

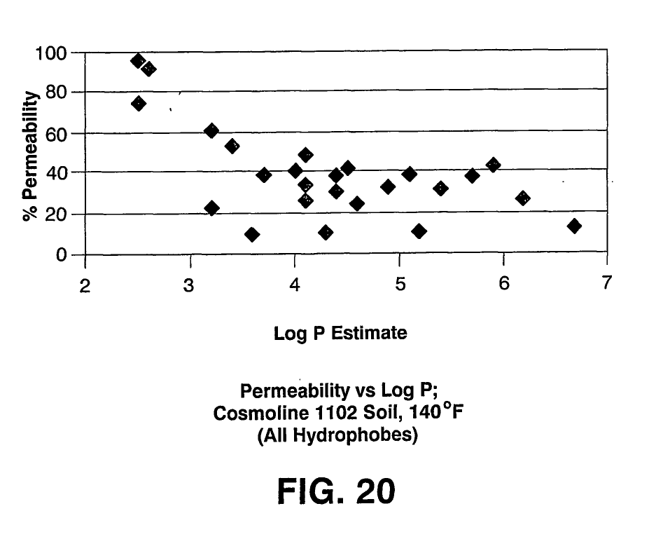

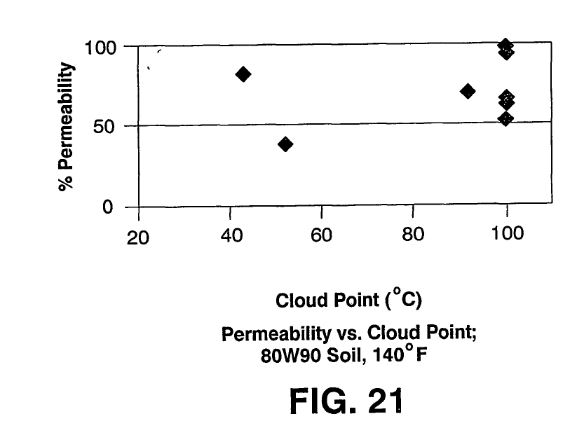

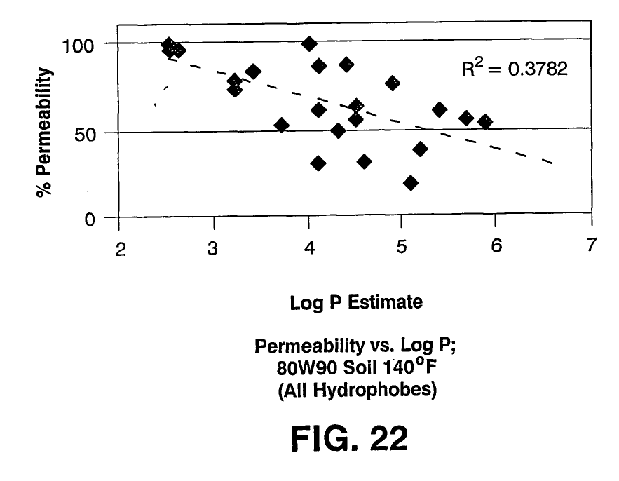

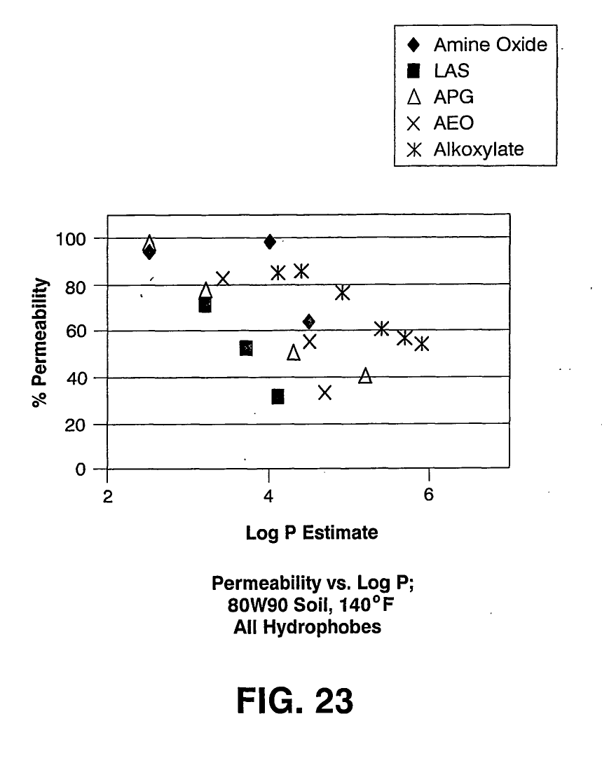

Plots of Permeability vs. Cloud Point and of Permeabilty vs. Log P for the two soils are given in FIGS. 19-22 and 16 and FIGS. 20 and 21 (a cloud point value of 100° C. was used for surfactants that do not exhibit a cloud point). There does not appear to be a correlation between permeability and cloud point for either soil system (FIGS. 19 and 21). In the Cosmoline® 1102 system, the surfactant permeability results decrease rapidly with increasing Log P and then level off at a Log P value of about 4 (FIG. 20). In the Pennzoil® 80W90 soil system, the surfactant permeability results decrease steadily with increasing Log P estimates (FIGS. 22 and 23). Thus, the type of soil present has a significant effect on the permeability results. The differences observed may be due to the emulsification propensity of the Cosmoline® 1102.

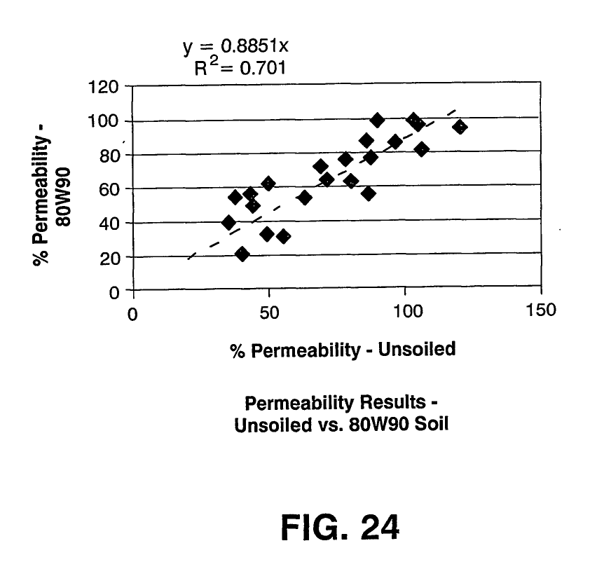

The Pennzoil® system results appear to be similar to those obtained for the unsoiled system (FIG. 14). A plot of surfactant permeability results in the unsoiled system vs. those obtained in the Pennzoil® 80W90 system is shown in FIG. 24.

### EXAMPLE 4

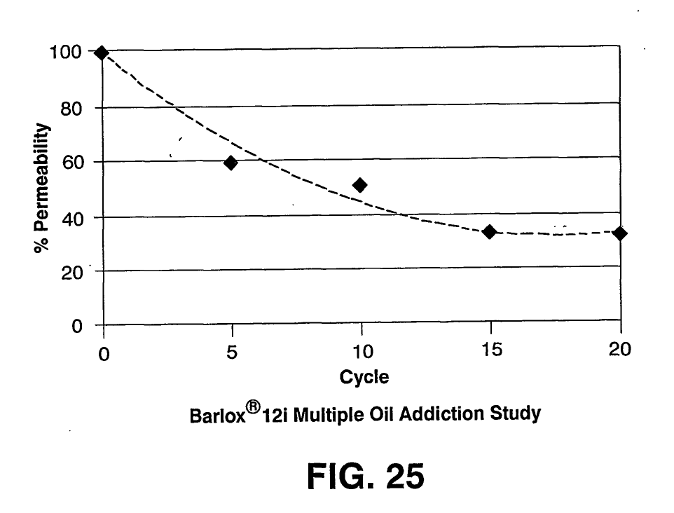

The Barlox® 12i surfactant was evaluated further to study the effect of surfactant concentration and multiple oil additions on permeability results. The initial bath surfactant concentration was increased to two and one half (2.5) times that of the standard diluted conditions (i.e., 0.375% not corrected for solids level). Cosmoline® 1102 oil was added at 1%, temperature was equilibrated to 140° F. and the membrane operation was started. A permeate sample was collected at Cycle 5. Then, 1% additional Cosmoline® 1102 was added to the customer bath (based on total customer and feed bath volumes). A second permeate sample was collected after 5 additional cycles (i.e., Cycle 10). Again, 1% more Cosmoline® oil was added and the process repeated for Cycles 15 and 20. The permeability results are given in Table O and plotted in FIG. 25.

TABLE O
Barlox ® 12i Multiple Oil Addition Study Permeability Results.*

| Cycle | % Permeability |
|---|---|
| 0 | 100 |
| 5 | 59 |
| 10 | 50 |
| 15 | 32 |
| 20 | 31 |

*Barlox ® 12i concentration: 0.375%; 1% Cosmoline ® 1102 added every 5 cycles.

The Barlox® 12i level in the permeate decreases after each addition of Cosmoline® 1102 until Cycle 15, at which point the permeate concentration does not significantly change. The Cycle 5 permeate result of 59% is significantly higher than the 40% permeability result for the Barlox® 12i base case (Table N), while the cycle 15 and 20 result of 31-32% are lower but probably not significantly different than the base case. The simplest explanation for these results is that the Cosmoline® 1102 exhaustively extracts about 65% of the Barolx® 12i. Assuming the extraction endpoint falls somewhere between the Cycle 10 and the Cycle 15 result, a ratio of about 5.3:1 to 8:1 of Cosmoline® 1102: Barlox® 12i is needed for complete extraction (i.e., 2-3% oil:0.375% surfactant). For the base case study the ratio of oil:surfactant is 6.7:1, also resulting in complete extraction. The existence of an extraction endpoint implies that there is a specific surfactant structure(s) that is being selectively removed by the Cosmoline® while the remaining surfactant structure(s) are not affected.

### EXAMPLE 6

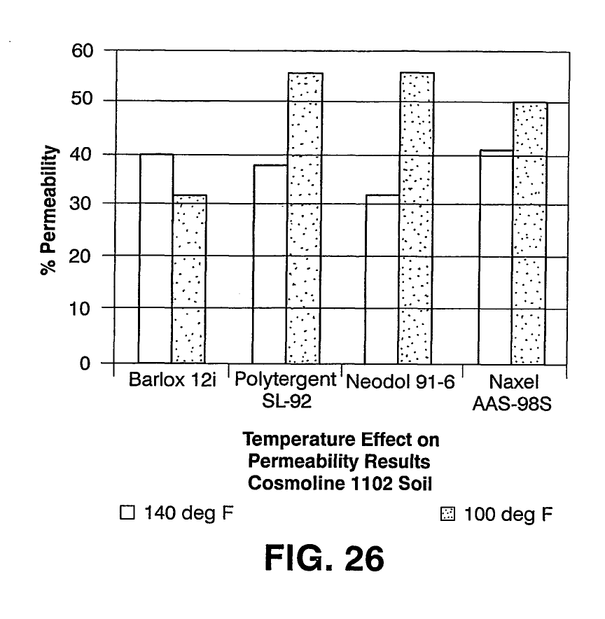

The permeability of four surfactants was evaluated at 100° F. in the presence of 1% Cosmoline® 1102 oil. Two of the surfactants have cloud points (Neodol® 91-6 and Poly-Tergent® SL-92) while the other two surfactants do not have cloud points (Barlox® 12i and Naxel® AAS-98S). The results are listed in Table N and are plotted in FIG. 26 with a comparison to the 140° F. results.

TABLE P
Effect of Temperature on Surfactant Permeability.

| | % Permeability | % Permeability |
|---|---|---|
| Surfactant | (140° F.) | (100° F.) |
| Barlox ® 12i | 40 | 32 |
| Polytergent ® SL-92 (P1) | 48 (Ave = 38) | 63 (Ave = 56) |
| Polytergent ® SL-92 (P2) | 38 | 61 |
| Polytergent ® SL-92 (P3) | 32 | 55 |
| Polytergent ® SL-92 (P4) | 31 | 50 |
| Polytergent ® SL-92 (P5) | 37 | 53 |
| Polytergent ® SL-92 (P6) | 42 | 54 |
| Neodol ® 91-6 (C9) | 33 (Ave = 32) | 55 (Ave = 56) |
| Neodol ® 91-6 (C10) | 24 | 52 |
| Neodol ® 91-6 (C11) | 38 | 62 |
| Naxel ® AAS-98S/C10 | 60 (Ave = 41) | 68 (Ave = 50) |
| Naxel ® AAS-98S/C11 | 38 | 46 |
| Naxel ® AAS-98S/C12 | 26 | 37 |

The largest temperature related effect was seen in the two surfactants that have cloud points. The permeability results of the Neodol® 91-6 and of the Poly-Tergent® SL-92 increased the most upon lowering the system temperature from 140° F. to 100° F. These results are consistent with greater aqueous solubility of alkoxylated surfactants at lower temperatures. The Barlox® 12i and Naxel® AAS-98S exhibit good water solubility at both temperatures and thus, the permeability results are less temperature sensitive.

### EXAMPLE 7

Example 7 involves a fully formulated composition, Formula 3, as described in Table B and was tested in a soil system comprising a 1:1:1 ratio of Cosmoline® 1102, Pennzoil® 4096 SAE 80W90 GL-5 Multipurpose Gear Lube and Pennzoil® Multipurpose White Grease 705 (Pennzoil Corp., Houston, Tex.) and was run according to Example 1. The purpose of this test was to determine the recyclability of Barlox 12i.

The cycle 5 results showed that the permeability of Formula 3 is 72%. This result lies between the result of 40% permeability determined with the Cosmoline® 1102 only system and the result of 98% permeability measured for the Pennzoil® 80W90 only system. Though permeability in the White Grease only system was not investigated, it appears from the mixed soil results that the White Grease does not have a large detrimental effect on the Barlox® 12i permeability. The calculated Log P for the Barlox® 12i surfactant included therein is 4.

1. A recyclable cleaning composition for cleaning soils from hard surface articles, comprising an aqueous alkaline solution containing from 1% to 20% by weight of a synthetic detergent comprising at least one surfactant selected from the group consisting of (a) nonionic ethoxylated surfactants, (b) amine oxide surfactants, (c) anionic surfactants, (d) alkyl polyglucoside surfactants, (e) amphoteric surfactants, and (f) mixtures thereof, said detergent, after being soiled by the soils, having a degree of permeability through a membrane having pore size of about 0.05 to 5.0 microns, of at least 30% by weight of the surfactant contained therein under at least one set of soiled conditions and recyclable for re-use.

2. The composition according to claim 1, wherein said detergent comprises at least one surfactant having a Log P of less than about 4.5.

3. The composition according to claim 1, wherein the composition further comprises adjuvants selected from the group consisting of builders, corrosion inhibitors, anti-scaling materials, alkalinity electrolyes, hydrotropes, antifoam materials, wetting agents, solvents, other adjuvants and mixtures thereof.

4. The composition according to claim 3, wherein substantially all of said adjuvants permeate said membrane for recycle and re-use.

5. The composition according to claim 1, wherein the composition is effective at temperatures above 60° C.

6. The composition according to claim 1, wherein the composition is effective at temperatures below 60° C.

7. The composition according to claim 1, wherein the surfactant or the mixture of surfactants has a cloud point which is greater than the temperature at which the hard surface articles are cleaned.

8. A diluted cleaning composition comprising the composition of claim 1 and additional water, wherein said additional water comprises up to about 99.5% by weight of the diluted composition.

9. A process for the cleaning of soils from hard surface articles, which comprises:
a. immersing said articles at an operating temperature of from about 25° C. to about 60° C. in a cleaning composition comprising an aqueous alkaline solution containing from 1% to 20% by weight of a synthetic detergent comprising at least one surfactant selected from the group consisting of (a) nonionic ethoxylated surfactants, (b) amine oxide surfactants, (c) anionic surfactants, (d) alkyl polyglucoside surfactants, (e) amphoteric surfactants, and (f) mixtures thereof, having a degree of permeability through a membrane having pore size of about 0.05 to 5.0 microns of at least 30% by weight of the surfactant contained therein under at least one set of soiled conditions, and said solution optionally containing adjuvants selected from the group consisting of builders, corrosion inhibitors, anti-scaling materials, alkalinity electrolytes, hydrotropes, antifoam materials, wetting agents, solvents, other adjuvants and mixtures thereof;
b. separating the solution from said articles and filtering it through a membrane having a pore size within the range of 0.05 to 5.0 microns, with least 30% by weight of the surfactant permeating through the membrane resulting in a permeate; and
c. recycling the permeate for further cleaning of said articles.

10. The process according to claim 9, wherein the detergent comprises at least one surfactant having a Log P less than about 4.5.

11. The process according to claim 9, wherein substantially all of said adjuvants permeate through the membrane.

12. The process according to claim 9, wherein the composition used therein is effective at temperatures below 60° C.

13. The process according to claim 9, wherein the composition used therein is effective at temperatures above 60° C.

14. The process according to claim 9, wherein the surfactant or the mixture of surfactants used therein has a cloud point which is greater than the operating temperature.

15. A process for the cleaning of soils from hard surface articles, which comprises:
a. immersing said articles at an operating temperature of from about 25° C. to about 60° C. in the diluted cleaning composition of claim 8,
b. separating the diluted cleaning composition from said articles and filtering it through a membrane having a pore size within the range of 0.05 to 5.0 microns resulting in a permeate; and
c. recycling the permeate for further cleaning of said articles.

16. A process of recycling a cleaning composition for cleaning soils from hard surface articles, said cleaning composition prior to being soiled comprising an aqueous alkaline solution containing from 1% to 20% by weight of a synthetic detergent comprising at least one surfactant selected from the group consisting of (a) nonionic ethoxylated surfactants, (b) amine oxide surfactants, (c) anionic surfactants, (d) alkyl polyglucoside surfactants, (e) amphoteric surfactants, and (f) mixtures thereof, said detergent after being soiled by said hard surface articles, having a degree of permeability through a membrane having pore size of about 0.05 to 5.0 microns of at least 30% by weight of the surfactant contained therein under at least one set of soiled conditions and said composition optionally containing adjuvants selected from the group consisting of builders, corrosion inhibitors, anti-scaling materials, alkalinity electrolytes, hydrotropes, antifoam materials, wetting agents, solvents, other adjuvants and mixtures thereof, and recyclable for re-use, which process comprises:
a. filtering said soiled solution through a membrane having a pore size within the range of about 0.05 to 5.0 microns, with least 30% by weight of the surfactant permeating through the membrane resulting in a permeate; and
b. recycling the permeate for further cleaning of articles.

17. The process according to claim 16, wherein the detergent comprises at least one surfactant having a Log P of less than about 4.5.

18. The process according to claim 16, wherein substantially all of said adjuvants permeate through the membrane.

19. The process according to claim 16, wherein the composition used therein is effective at temperatures below 60° C.

20. The process according to claim 16, wherein the composition used therein is effective at temperatures above 60° C.

21. The process according to claim 16, wherein the surfactant or the mixture of surfactants used therein has a cloud point which is greater than the operating temperature.

22. A process of recycling the diluted cleaning composition of claim 8 after said composition has been soiled, which process comprises:
a. filtering said soiled composition through a membrane having a pore size within the range of about 0.05 to 5.0 microns resulting in a permeate; and
b. recycling the permeate for further cleaning of articles.

23. A method of reducing effluent waste stream from a cleaning process comprising recycling soiled cleaning compositions, said composition prior to soiling comprising an aqueous alkaline solution containing from 1% to 20% by weight of a synthetic detergent comprising at least one surfactant selected form the group consisting of (a) nonionic ethoxylated surfactants, (b) amine oxide surfactants, (c) anionic surfactants, (d) alkyl polyglucoside surfactants, (e) amphoteric surfactants, and (f) mixtures thereof, said detergent after being soiled, having a degree of permeability through a membrane having a pore size of about 0.05 to 5.0 microns of at least 30% by weight of the surfactant contained therein under at least one set of soiled conditions, and said composition optionally containing adjuvants selected from the group consisitng of builders, corrosion inhibitors, anti-scaling materials, alkalinity electrolytes, hydrotropes, antifoam materials, wetting agents, solvents, other adjuvants and mixtures thereof, and recyclable for re-use, which process comprises:
a. filtering said soiled solution through a membrane having pore size within the range of about 0.05 to 5.0 microns, with least 30% by weight of the surfactant permeating through the membrane resulting in a permeate and a retentate, and
b. recycling the permeate for further cleaning of articles, whereby the effluent waste stream is substantially reduced in volume through the recycling of the permeate and concentration of the retentate.

24. The process according to claim 23, wherein the detergent comprises at least one surfactant having a Log P of less than about 4.5.

25. The process according to claim 23, wherein substantially all of said adjuvants permeate through the membrane.

26. The process according to claim 23, wherein the composition used therein is effective at temperatures below 60° C.

27. The process according to claim 23, wherein the composition used therein is effective at temperatures above 60° C.

28. The process according to claim 23, wherein the surfactant or the mixture of surfactants used therein has a cloud point which is greater than the operating temperature.

29. A method of reducing effluent waste stream from a cleaning process comprising recycling the diluted cleaning composition of claim 8 after said diluted cleaning composition has been soiled, which process comprises:
a. filtering said soiled composition through a membrane having pore size within the range of about 0.05 to 5.0 microns, resulting in a permeate and a retentate, and
b. recycling the permeate for further cleaning of articles, whereby the effluent waste stream is substantially reduced in volume through the recycling of the permeate and concentration of the retentate.
